(19) United States
(12) Patent Application Publication
(10) Pub. No.: US 2024/0243853 A1
(43) Pub. Date: Jul. 18, 2024

(54) METHOD AND APPARATUS OF HANDLING OVERLAPPING BETWEEN NETWORK DRX DURATION AND HARQ FEEDBACK OCCASION FOR NETWORK ENERGY SAVINGS IN A WIRELESS COMMUNICATION SYSTEM

(71) Applicant: SAMSUNG ELECTRONICS CO., LTD., Suwon-si (KR)

(72) Inventors: Anil AGIWAL, Suwon-si (KR); Sangkyu BAEK, Suwon-si (KR)

(21) Appl. No.: 18/412,717

(22) Filed: Jan. 15, 2024

(30) Foreign Application Priority Data
Jan. 18, 2023 (KR) 10-2023-0007157

(51) Int. Cl. H04L 1/1829; H04W 76/28

(52) U.S. Cl. CPC H04L 1/1848; H04W 76/28

(57) ABSTRACT

The disclosure relates to a 5G or 6G communication system for supporting a higher data transmission rate. Specifically, the present disclosure provides method and apparatus for handling overlapping between DRX duration and HARQ feedback occasion with respect to NES. The method comprises: receiving, from a base station, configuration information for a network discontinuous reception (NW DRX) operation; receiving, from the base station, downlink data based on the NW DRX operation; identifying that an occasion for hybrid automatic repeat request (HARQ) information for the downlink data overlaps with a duration of the NW DRX operation; and transmitting, to the base station, the HARQ information for the downlink data in the occasion overlapping with the duration of the NW DRX operation.

### CROSS-REFERENCE TO RELATED APPLICATIONS

This application is based on and claims priority under 35 U.S.C. § 119 to Korean Patent Application No. 10-2023-0007157 filed on Jan. 18, 2023, in the Korean Intellectual Property Office, the disclosure of which is incorporated by reference herein in its entirety.

### BACKGROUND

### 2. Field

The disclosure relates to a wireless communication system (or a mobile communication system). Specifically, the disclosure relates to an apparatus, a method and a system for handling an overlapping between network discontinuous reception (DRX) duration and hybrid automatic repeat request (HARQ) feedback occasion for network energy saving (NES) in wireless communication system.

### 2. Description of Related Art

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Recently, there are needs to enhance handling of overlapping between DRX duration and HARQ occasion with respect to network energy saving.

Aspects of the disclosure are to address at least the above-mentioned problems and/or disadvantages and to provide at least the advantages described below. Accordingly, an aspect of the disclosure is to provide a communication method and system for converging a fifth generation (5G) communication system for supporting higher data rates beyond a fourth generation (4G).

In accordance with an aspect of the disclosure, a method performed by a terminal is provided. The method comprises: receiving, from a base station, configuration information for a network discontinuous reception (NW DRX); receiving, from the base station, downlink data; identifying that an occasion for hybrid automatic repeat request (HARQ) information for the downlink data overlaps with a duration of the NW DRX; and transmitting, to the base station, the HARQ information for the downlink data in the occasion overlapping with the duration of the NW DRX

In accordance with another aspect of the disclosure, a terminal is provided. The terminal comprises: a transceiver; and a controller coupled with the transceiver and configured to: receive, from a base station, configuration information for a network discontinuous reception (NW DRX), receive, from the base station, downlink data, identify that an occasion for hybrid automatic repeat request (HARQ) information for the downlink data overlaps with a duration of the NW DRX, and transmit, to the base station, the HARQ information for the downlink data in the occasion overlapping with the duration of the NW DRX.

In accordance with another aspect of the disclosure, a method performed by a base station is provided. The method comprises: transmitting, to a terminal, configuration information for a network discontinuous reception (NW DRX); transmitting, to the terminal, downlink data; and receiving, from the terminal, hybrid automatic repeat request (HARQ) information for the downlink data in an occasion for HARQ information that overlaps with a duration of the NW DRX, by temporarily resuming a reception during the duration of the NW DRX.

In accordance with another aspect of the disclosure, a base station is provided. The base station comprises: a transceiver; and a controller coupled with the transceiver and configured to: transmit, to a terminal, configuration information for a network discontinuous reception (NW DRX), transmit, to the terminal, downlink data, and receive, from the terminal, hybrid automatic repeat request (HARQ) information for the downlink data in an occasion for HARQ information that overlaps with a duration of the NW DRX, by temporarily resuming a reception during the duration of the NW DRX.

According to various embodiments of the disclosure, network energy saving can be enhanced according to efficient handling of DRX duration and HARQ feedback occasion.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of DRX cycle in accordance with an embodiment of the present disclosure;

FIG. 2 illustrates another example of PDCCH reception with respect to overlap of network DRX duration and HARQ feedback occasion in accordance with an embodiment of the present disclosure

FIG. 3 illustrates another example of PDCCH reception with respect to overlap of network DRX duration and HARQ feedback occasion in accordance with an embodiment of the present disclosure;

FIG. 4 illustrates another example of PDCCH reception with respect to overlap of network DRX duration and HARQ feedback occasion in accordance with an embodiment of the present disclosure;

FIG. 5 illustrates another example of PDCCH reception with respect to overlap of network DRX duration and HARQ feedback occasion in accordance with an embodiment of the present disclosure;

FIG. 6 illustrates another example of PDCCH reception with respect to overlap of network DRX duration and HARQ feedback occasion in accordance with an embodiment of the present disclosure;

FIG. 7 illustrates another example of PDCCH reception with respect to overlap of network DRX duration and HARQ feedback occasion in accordance with an embodiment of the present disclosure;

FIG. 8 illustrates another example of PDCCH reception with respect to overlap of network DRX duration and HARQ feedback occasion in accordance with an embodiment of the present disclosure;

FIG. 9 illustrates another example of PDCCH reception with respect to overlap of network DRX duration and HARQ feedback occasion in accordance with an embodiment of the present disclosure;

FIG. 10 illustrates another example of PDCCH reception with respect to overlap of network DRX duration and HARQ feedback occasion in accordance with an embodiment of the present disclosure;

FIG. 11 illustrates a terminal according to an embodiment of the present disclosure; and

FIG. 12 illustrates a base station according to an embodiment of the present

### DISCLOSURE

Throughout the drawings, like reference numerals will be understood to refer to like parts, components, and structures.

### DETAILED DESCRIPTION

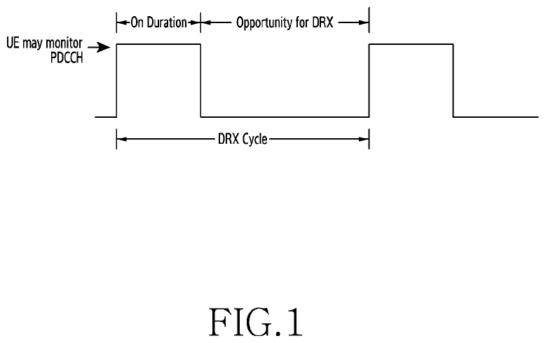

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit,” “module” or the like may refer to a software component or hardware component, such as, for example, a field-programmable gate array (FPGA) or an application-specific integrated circuit (ASIC) capable of carrying out a function or an operation. However, a “unit,” or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5GNB), or gNB.

The “UE” is an entity communicating with a BS and may be referred to as UE, device, mobile station (MS), mobile equipment (ME), or terminal.

In the fifth generation wireless communication system operating in higher frequency (mmWave) bands, a UE and a gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an Interference signal. By using beamforming technique, a transmitter can make plurality of transmit beam patterns of different directions. Each of these transmit beam patterns can be also referred as TX beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of RX beam patterns of different directions. Each of these receive patterns can be also referred as RX beam.

The fifth generation wireless communication system, supports standalone mode of operation as well dual connectivity (DC). In DC a multiple Rx/Tx UE may be configured to utilize resources provided by two different nodes (or base stations) connected via non-ideal backhaul. One node acts as the master node (MN) and the other as the secondary node (SN). The MN and SN are connected via a network interface and at least the MN is connected to the core network. NR also supports multi-RAT dual connectivity (MR-DC) operation whereby a UE in radio resource control (RRC) connected (RRC_CONNECTED) is configured to utilize radio resources provided by two distinct schedulers, located in two different nodes connected via a non-ideal backhaul and providing either evolved UMTS terrestrial radio access (E-UTRA) (i.e., if the node is an ng-eNB) or NR access (i.e., if the node is a gNB). In NR for a UE in RRC_CONNECTED not configured with carrier aggregation (CA)/DC there is only one serving cell comprising of the primary cell.

For a UE in RRC_CONNECTED configured with CA/DC the term “serving cells” is used to denote the set of cells comprising of the Special Cell(s) and all secondary cells. In NR the term master cell group (MCG) refers to a group of serving cells associated with the master node, comprising of the primary cell (pCell) and optionally one or more secondary cells (sCells). In NR the term secondary cell group (SCG) refers to a group of serving cells associated with the secondary node, comprising of the primary SCG cell (PSCell) and optionally one or more sCells. In NR pCell refers to a serving cell in MCG, operating on the primary frequency, in which the UE either performs the initial connection establishment procedure or initiates the connection re-establishment procedure. In NR for a UE configured with CA, sCell is a cell providing additional radio resources on top of special Cell. PSCell refers to a serving cell in SCG in which the UE performs random access when performing the reconfiguration with sync procedure. For dual connectivity operation the term SpCell (i.e., special cell) refers to the pCell of the MCG or the PSCell of the SCG, otherwise the term special cell refers to the pCell.

PDCCH in fifth generation wireless communication system: In the fifth generation wireless communication system, physical downlink control channel (PDCCH) is used to schedule downlink (DL) transmissions on physical downlink shared channel (PDSCH) and uplink (UL) transmissions on physical uplink shared channel (PUSCH), where the downlink control information (DCI) on PDCCH includes: downlink assignments containing at least modulation and coding format, resource allocation, and hybrid automatic repeat request (HARQ) information related to downlink shared channel (DL-SCH); Uplink scheduling grants containing at least modulation and coding format, resource allocation, and hybrid-ARQ information related to uplink shared channel (UL-SCH). In addition to scheduling, PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB(s)) and orthogonal frequency division multiplexing (OFDM) symbol(s) where the UE may assume no transmission is intended for the UE; transmission of transmission power control (TPC) commands for physical uplink control channel (PUCCH) and PUSCH; transmission of one or more TPC commands for SRS transmissions by one or more UEs; switching a UE's active bandwidth part; initiating a random access procedure. A UE monitors a set of PDCCH candidates in the configured monitoring occasions in one or more configured control resource sets (CORESETs) according to the corresponding search space configurations. A CORESET consists of a set of PRBs with a time duration of 1 to 3 OFDM symbols. The resource units resource element groups (REGs) and control channel elements (CCEs) are defined within a CORESET with each CCE comprising a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own demodulation reference signal (DMRS). Quadrature phase shift keying (QPSK) modulation is used for PDCCH.

In fifth generation wireless communication system, a list of search space configurations is signaled by GNB for each configured BWP wherein each search configuration is uniquely identified by an identifier. Identifier of search space configuration to be used for specific purpose such as paging reception, SI reception, random access response reception is explicitly signaled by gNB. In NR search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion (s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots to x+duration where the slot with number “x” in a radio frame with number “y” satisfies the equation below:
(y*(number of slots in a radio frame)+x−Monitoring-offset-PDCCH-slot) mod (Monitoring-periodicity-PDCCH-slot)=0;

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. search space configuration includes the identifier of coreset configuration associated with it. A list of coreset configurations is signaled by GNB for each configured BWP wherein each coreset configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported SCS is pre-defined in NR. Each coreset configuration is associated with a list of Transmission configuration indicator (TCI) states. One DL reference signal (RS) identifier (ID) (synchronization signal and physical broadcast channel block (SSB) or channel state information reference signal (CSI-RS)) is configured per TCI state. The list of TCI states corresponding to a coreset configuration is signaled by gNB via RRC signaling. One of the TCI state in TCI state list is activated and indicated to a UE by a gNB via medium access control (MAC) control element (CE). TCI state indicates the DL TX beam (DL TX beam is quasi collocated (QCLed) with SSB/CSI-RS of TCI state) used by GNB for transmission of PDCCH in the PDCCH monitoring occasions of a search space. For PDSCH, TCI state of scheduling PDCCH can be used for scheduled PDSCH. Alternately, TCI state of the PDCCH for the lowest corset ID in the slot is used for PDSCH. Alternately combination of RRC+MAC CE+DCI is used to indicate the TCI state for PDSCH. RRC configures a list of TCI state, MAC CE indicates a subset of these TCI states and DCI indicates one of the TCI state from list of TCI states indicated in MAC CE.

Bandwidth adaptation in fifth generation wireless communication system: In fifth generation wireless communication system bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a bandwidth part (BWP). BA is achieved by configuring RRC connected UE with BWP(s) and telling the UE which of the configured BWPs is currently the active one. When BA is configured, the UE only may monitor PDCCH on the one active BWP i.e., the UE may not monitor PDCCH on the entire DL frequency of the serving cell.

In a RRC connected state, the UE is configured with one or more DL and UL BWPs, for each configured Serving Cell (i.e., PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the MAC entity itself upon initiation of random access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a serving cell is indicated by either RRC or PDCCH. For unpaired spectrum, a DL BWP is paired with a UL BWP, and BWP switching is common for both UL and DL. Upon expiry of BWP inactivity timer, a UE switches to the active DL BWP to the default DL BWP or initial DL BWP (if default DL BWP is not configured).

Random access in fifth generation wireless communication system: In the 5G wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UE in a RRC CONNECTED state. Several types of random access procedure is supported.

Paging in fifth generation wireless communication system: In the 5th generation (also referred as new radio (NR)) wireless communication system, a UE can be in one of the following RRC states: RRC IDLE, RRC INACTIVE and RRC CONNECTED. The RRC states can further be characterized as follows.

In a RRC_IDLE state, a UE specific discontinuous reception (DRX) may be configured by upper layers (i.e., non-access stratum (NAS)). The UE, monitors Short Messages transmitted with paging radio network temporary identifier (P-RNTI) over DCI; monitors a Paging channel for core network (CN) paging using 5G-S-temporary mobile subscription identifier (5G-S-TMSI); performs neighboring cell measurements and cell (re-)selection; Acquires system information and can send SI request (if configured).

In a RRC_INACTIVE state, a UE specific DRX may be configured by upper layers or by RRC layer; In this state, the UE stores the UE inactive access stratum (AS) context. A RAN-based notification area is configured by RRC layer. The UE monitors short messages transmitted with P-RNTI over DCI; Monitors a Paging channel for CN paging using 5G-S-TMSI and RAN paging using full I-RNTI; performs neighboring cell measurements and cell (re-)selection; performs radio access network (RAN)-based notification area updates periodically and when moving outside the configured RAN-based notification area; Acquires system information and can send SI request (if configured).

In the RRC_CONNECTED, the UE stores the AS context. Unicast data is transmitted/received to/from the UE. At lower layers, the UE may be configured with a UE specific DRX. The UE monitors short messages transmitted with P-RNTI over DCI, if configured; monitors control channels associated with the shared data channel to determine if data is scheduled for it; provides channel quality and feedback information; performs neighboring cell measurements and measurement reporting; acquires system information.

The 5G or next generation radio access network (NG-RAN) based on NR consists of NG-RAN nodes where NG-RAN node is a gNB, providing NR user plane and control plane protocol terminations towards the UE. The gNBs are also connected by means of the NG interfaces to the 5GC, more specifically to the access and mobility management function (AMF) by means of the NG-C interface and to the user plane function (UPF) by means of the NG-U interface. In the 5th generation (also referred as NR or New Radio) wireless communication system, the UE may use DRX in a RRC_IDLE and a RRC INACTIVE state in order to reduce power consumption. In the RRC_IDLE/RRC_INACTIVE state UE wake ups at regular intervals (i.e., every DRX cycle) for short periods to receive paging, to receive SI update notification and to receive emergency notifications.

A paging message is transmitted using PDSCH. PDCCH is addressed to P-RNTI if there is a paging message in PDSCH. P-RNTI is common for all UEs. A UE identity (i.e., S-TMSI for RRC IDLE UE or I-RNTI for RRC_INACTIVE UE) is included in paging message to indicate paging for a specific UE. Paging message may include multiple UE identities to page multiple UEs. Paging message is broadcasted (i.e., PDCCH is masked with P-RNTI) over data channel (i.e., PDSCH). SI update and emergency notifications are included in DCI and PDCCH carrying this DCI is addressed to P-RNTI. In the RRC idle/inactive mode, the UE monitors one paging occasion (PO) every DRX cycle. In the RRC idle/inactive mode, the UE monitors PO in initial DL BWP.

In a RRC connected state, the UE monitors one or more POs to receive SI update notification and to receive emergency notifications. In the RRC connected state, the UE can monitor any PO in paging DRX cycle and monitors at least one PO in SI modification period. In the RRC idle/inactive mode, the UE monitors PO every DRX cycle in its active DL BWP. A PO is a set of “S” PDCCH monitoring occasions for paging, where “S” is the number of transmitted SSBs (i.e., the SSB consists of primary synchronization signal (PSS) and secondary synchronization signal (SSS) and physical broadcast channel (PBCH)) in cell. The UE first determines the paging frame (PF) and then determines the PO with respect to the determined PF. One PF is a radio frame (10 ms).
The PF for a UE is the radio frame with system frame number “SFN” which satisfies the equation (SFN+PF_offset) mod T=(T div N)*(UE_ID mod N).
Index (i_s), indicating the index of the PO is determined by i_s=floor (UE_ID/N) mod Ns.
Tis DRX cycle of the UE.
In a RRC_INACTIVE state, T is determined by the shortest of the UE specific DRX value configured by RRC, the UE specific DRX value configured by NAS, and a default DRX value broadcast in system information.
In a RRC_IDLE state, T is determined by the shortest of UE specific DRX value configured by NAS, and a default DRX value broadcast in system information. If the UE specific DRX is not configured by upper layers (i.e., NAS), the default value is applied.
N: number of total paging frames in T.
Ns: number of paging occasions for a PF.
PF_offset: offset used for PF determination.
UE_ID: 5G-S-TMSI mod 1024.
Parameters Ns, nAndPagingFrameOffset, and the length of default DRX Cycle are signaled in system information block 1 (SIB1). The values of N and PF_offset are derived from the parameter nAndPagingFrameOffset. If the UE has no 5G-S-TMSI, for instance when the UE has not yet registered onto the network, the UE may use as default identity UE_ID=0 in the PF and i_s formulas above.
The PDCCH monitoring occasions for paging are determined based on paging search space configuration (paging-SearchSpace) signaled by gNB.
When SearchSpaceId=0 is configured for pagingSearchSpace, the PDCCH monitoring occasions for paging are same as for RMSI. When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.
When SearchSpaceld other than 0 is configured for pagingSearchSpace, the UE monitors the (i_s+1)th PO. The PDCCH monitoring occasions for paging are determined based on paging search space configuration (paging-SearchSpace) signaled by gNB. The PDCCH monitoring occasions for paging which are not overlapping with UL symbols (determined according to tdd-UL-DL-ConfigurationCommon) are sequentially numbered from zero starting from the 1st PDCCH monitoring occasion for paging in the PF. The gNB may signal parameter firstPDCCH-MonitoringOccasionOfPO for each PO corresponding to a PF. When firstPDCCH-MonitoringOccasionOfPO is signalled, the (i_s+1)th PO is a set of “S” consecutive PDCCH monitoring occasions for paging starting from the PDCCH monitoring occasion number indicated by firstPDCCH-MonitoringOccasionOfPO (i.e., the (i_s+1)th value of the firstPDCCH-MonitoringOccasionOfPO parameter). Otherwise, the (i_s+1)th PO is a set of “S” consecutive PDCCH monitoring occasions for paging starting from the (i_sS)th PDCCH monitoring occasion for paging. “S” is the number of actual transmitted SSBs determined according to parameter ssb-PositionsInBurst signalled in SystemInformationBlock1 received from gNB. The parameter first-PDCCH-MonitoringOccasionOfPO is signalled in SIB1 for paging in initial DL BWP. For paging in a DL BWP other than the initial DL BWP, the parameter first-PDCCH-MonitoringOccasionOfPO is signaled in the corresponding BWP configuration.

FIG. 1 illustrates an example of DRX cycle in accordance with an embodiment of the present disclosure.

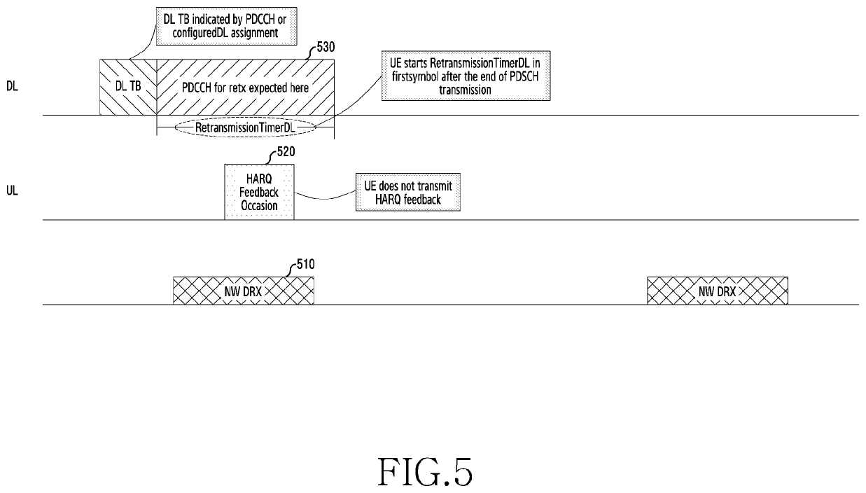

Connected Mode UE specific DRX: In 5G wireless communication system, the PDCCH monitoring activity of the UE in RRC connected mode is governed by DRX. When DRX is configured, the UE may not continuously monitor PDCCH (addressed to cell RNTI (C-RNTI), cancellation indication RNTI (CI-RNTI), configured scheduling RNTI (CS-RNTI), interruption RNTI (INT-RNTI), slot format indication RNTI (SFI-RNTI), semi-persistent CSI RNTI (SP-CSI-RNTI), TPC-PUCCH-RNTI, TPC-PUSCH-RNTI, TPC-SRS-RNTI, availability indicator RNTI (AI-RNTI), sidelink RNTI (SL-RNTI), sidelink configured scheduling RNTI (SLCS-RNTI) and SL Semi-Persistent Scheduling V-RNTI). DRX is characterized by the following:
on-duration: duration that the UE waits for, after waking up, to receive PDCCHs. If the UE successfully decodes a PDCCH, the UE stays awake and starts the inactivity timer;
inactivity-timer: duration that the UE waits to successfully decode a PDCCH, from the last successful decoding of a PDCCH, failing which the UE can go back to sleep. The UE may restart the inactivity timer following a single successful decoding of a PDCCH for a first transmission only (i.e., not for retransmissions);
retransmission-timer: duration until a retransmission can be expected;
cycle: specifies the periodic repetition of the on-duration followed by a possible period of inactivity (see FIG. 5 below); and
active-time: total duration that the UE monitors PDCCH. This includes the “on-duration” of the DRX cycle, the time UE is performing continuous reception while the inactivity timer has not expired, and the time when the UE is performing continuous reception while waiting for a retransmission opportunity.

Serving cells of a MAC entity may be configured by RRC in two DRX groups with separate DRX parameters. When RRC does not configure a secondary DRX group, there is only one DRX group and all serving cells belong to that one DRX group. When two DRX groups are configured, each serving cell is uniquely assigned to either of the two groups. The DRX parameters that are separately configured for each DRX group are: drx-onDuration Timer, drx-Inactivity Timer. The DRX parameters that are common to the DRX groups are: drx-SlotOffset, drx-Retransmission TimerDL, drx-Retransmission TimerUL, drx-LongCycleStartOffset, drx-ShortCycle (optional), drx-ShortCycleTimer (optional), drx-HARQ-RTT-TimerDL, drx-HARQ-RTT-TimerUL, downlinkHARQ-FeedbackDisabled (optional) and uplinkHARQ-Mode (optional).

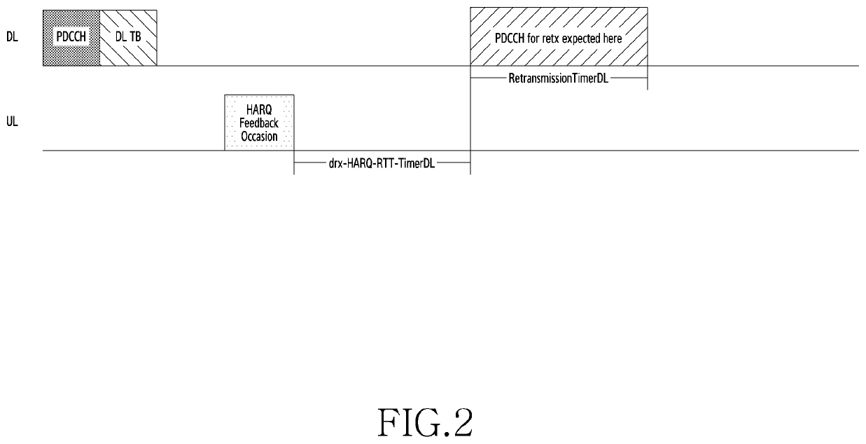

FIG. 2 illustrates another example of PDCCH reception with respect to overlap of network DRX duration and HARQ feedback occasion in accordance with an embodiment of the present disclosure.

When DRX is configured, the Active Time for Serving Cells in a DRX group includes the time while:
drx-onDurationTimer or drx-Inactivity Timer configured for the DRX group is running; or
drx-Retransmission TimerDL, drx-Retransmission TimerUL or drx-Retransmission TimerSL is running on any Serving Cell in the DRX group; or
ra-ContentionResolutionTimer or msgB-Response Window is running; or
a Scheduling Request is sent on PUCCH and is pending. If this Serving Cell is part of a non-terrestrial network, the active time is started after the Scheduling Request transmission that is performed when the SR_COUNTER is 0 for all the SR configurations with pending SR(s) plus the UE-gNB RTT; or
a PDCCH indicating a new transmission addressed to the C-RNTI of the MAC entity has not been received after successful reception of a random access response for the random access preamble not selected by the MAC entity among the contention-based random access preamble.

According to the current operation when connected mode UE specific DRX is configured:
if the PDCCH indicates a DL transmission or if a MAC PDU is received in a configured downlink assignment for unicast:
   start the drx-HARQ-RTT-TimerDL for the corresponding HARQ process in the first symbol after the end of the corresponding transmission carrying the DL HARQ feedback;
   stop the drx-Retransmission TimerDL for the corresponding HARQ process.
if a drx-HARQ-RTT-TimerDL expires:
   if the data of the corresponding HARQ process was not successfully decoded:
      start the drx-Retransmission TimerDL for the corresponding HARQ process in the first symbol after the expiry of drx-HARQ-RTT-TimerDL.
A UE is considered in active time when drx-Retransmission TimerDL is running

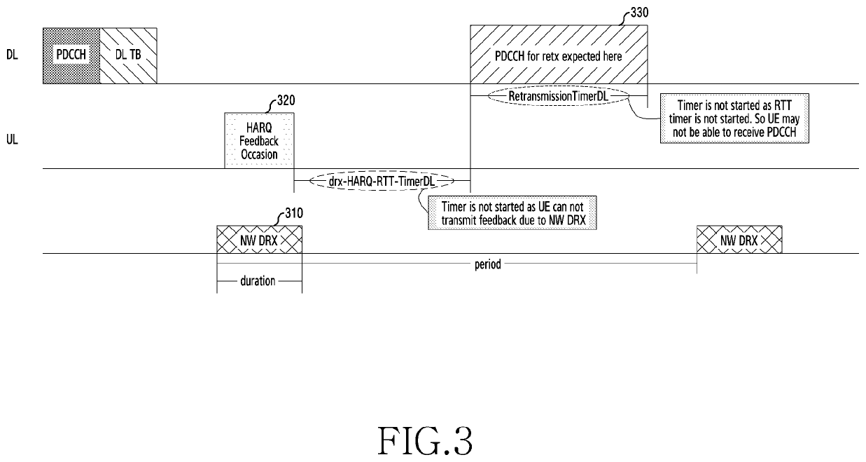

FIG. 3 illustrates another example of PDCCH reception with respect to overlap of network DRX duration and HARQ feedback occasion in accordance with an embodiment of the present disclosure.

Meanwhile, for network energy savings, Cell discontinuous transmission (DTX) and/or Cell DRX can be configured wherein:
periodic cell DTX/DRX pattern is configured by UE-specific RRC signaling message.
Cell DTX and Cell DRX modes can be configured and operated separately (e.g., one RRC configuration set for DL and the other set for UL).
A UE specific DRX can be configured in a cell supporting Cell DTX and/or Cell DRX.

As shown in FIG. 3, if HARQ feedback occasion overlaps with NW DRX duration, HARQ feedback is not transmitted (310, 320). As per current operation, drx-HARQ-RTT-TimerDL is not started as a UE has not transmitted HARQ feedback. Since drx-HARQ-RTT-TimerDL is not started, RetransmissionTimerDL is also not started (330). So, the UE may not be able to receive PDCCH for retransmission if both on duration timer and inactivity timer are also not running. When on duration timer and inactivity timer are not running, running Retransmission TimerDL timer ensures that the UE can receive PDCCH for retransmission.

### [Method 1]

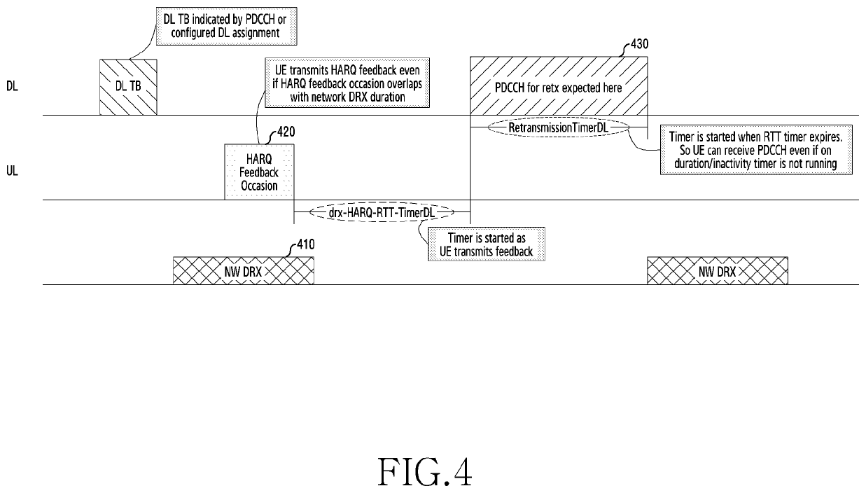

FIG. 4 illustrates another example of PDCCH reception with respect to overlap of network DRX duration and HARQ feedback occasion in accordance with an embodiment of the present disclosure.

A UE is in a RRC_CONNECTED state. The UE is configured with connected mode DRX configuration (as described earlier) using RRC signaling. For network energy savings, Cell DTX and/or Cell DRX can be configured wherein periodic cell DTX/DRX pattern is configured by UE-specific RRC signaling message. Cell DTX and Cell DRX modes can be configured and operated separately (e.g., one RRC configuration set for DL and the other set for UL). The UE specific DRX can be configured in a cell supporting Cell DTX and/or Cell DRX.

Periodic cell DTX pattern may be configured by a “duration” and “period” field wherein during the “duration” interval which occurs periodically every “period,”,” cell does not perform transmission (or stops certain transmissions (e.g., PDSCH, PBCH, SSBs, etc.). Alternately, periodic cell DTX pattern may be configured by a “duration” and “period” field wherein during the “duration” interval which occurs periodically every “period,”,” cell perform transmission and during the interval “period-duration” cell does not perform transmission (or stops certain transmissions (e.g., PDSCH, PBCH, SSBs, etc.)).

Periodic cell DRX pattern may be configured by a “duration” and “period” field wherein during the “duration” interval which occurs periodically every “period,”,” cell does not perform reception (or stops certain receptions e.g., PUCCH, PUSCH, PRACH etc.). Alternately, periodic cell DRX pattern may be configured by a “duration” and “period” field wherein during the “duration” interval which occurs periodically every “period,” cell perform reception and during the interval ‘period-duration’ cell does not perform reception (or stops certain receptions e.g., PUCCH, PUSCH, physical random access channel (PRACH) etc.). During the cell level DRX duration where a network (i.e., base station) does not receive transmission (or certain transmissions) from a UE on the uplink of that cell, the UE does not transmit (or does not transmit) certain transmissions in uplink of that cell.

A UE (or MAC entity in the UE) receives PDCCH indicating a DL/PDSCH transmission (i.e., resources for DL/PDSCH transmission) or the UE receives a MAC PDU in a configured downlink assignment (indicated by configured grant type 1 or configured grant type 2 configuration indicating periodic resources for DL/PDSCH transmission) for unicast (as shown in FIG. 4):
If HARQ feedback occasion for transmitting the DL HARQ feedback for the DL/PDSCH transmission (indicated by PDCCH or configured downlink assignment) overlaps (partially or fully) with network DRX duration (i.e., cell level DRX duration of cell on which HARQ feedback is to be transmitted (410); this can be same as or can be different from the cell in which DL/PDSCH transmission indicated by PDCCH or configured downlink assignment is received; HARQ feedback is transmitted on SpCell or PUCCH SCell, DL transmission can be on SpCell or PUCCH SCell or any other SCell):
   Instead of skipping the DL HARQ feedback, a UE or (MAC entity in the UE) transmits DL HARQ feedback in HARQ feedback occasion (420);
   A UE or (MAC entity in the UE) starts the drx-HARQ-RTT-TimerDL for the corresponding HARQ process in the first symbol after the end of the corresponding transmission carrying the DL HARQ feedback;
   A UE or (MAC entity in the UE) stops the drx-Retransmission TimerDL for the corresponding HARQ process.
Else (non-overlapping case):
   A UE or (MAC entity in the UE) transmits DL HARQ feedback in HARQ feedback occasion. The UE or (MAC entity in the UE) starts the drx-HARQ-RTT-TimerDL for the corresponding HARQ process in the first symbol after the end of the corresponding transmission carrying the DL HARQ feedback; the UE or (MAC entity in the UE) stops the drx-Retransmission TimerDL for the corresponding HARQ process.
if a drx-HARQ-RTT-TimerDL expires:
   if the data of the corresponding HARQ process was not successfully decoded:
      A UE or (MAC entity in the UE) starts the drx-Retransmission TimerDL for the corresponding HARQ process in the first symbol after the expiry of drx-HARQ-RTT-TimerDL (430).
Cell on which HARQ feedback is to be transmitted by a UE or (MAC entity in the UE) can be same as or can be different from the cell in which DL/PDSCH transmission indicated by PDCCH or configured downlink assignment is received; HARQ feedback is transmitted on SpCell or PUCCH SCell, DL transmission can be on SpCell or PUCCH SCell or any other SCell. PDCCH indicating DL transmission can be received from a cell, same or different from the cell on which indicated DL/PDSCH transmission is received by the UE or (MAC entity in the UE).

Base station configures cell specific DRX for one or more serving cells. During the cell level DRX duration of a cell, a network (i.e., base station) does not receive transmission (or certain transmissions) from a UE on the uplink of that cell.

Base station transmits PDCCH indicating resources for DL transmission. Base station transmits DL transport block (TB) in indicated resources (these resources are PDSCH resources of a cell). Resources for DL transmission can also be a configured downlink assignment (indicated by configured grant type 1 or configured grant type 2 configuration indicating periodic resources for DL/PDSCH transmission) for unicast.
Upon transmitting the DL TB, HARQ feedback is expected from a UE in HARQ feedback occasion corresponding to the DL TB.
HARQ feedback occasion for receiving the DL HARQ feedback for the DL transmission (indicated by PDCCH or configured downlink assignment) overlaps (partially or fully) with network DRX duration (i.e., cell level DRX duration of cell on which HARQ feedback is to be received):
   Instead of skipping the reception of DL HARQ feedback in the HARQ feedback occasion, base station receives DL HARQ feedback in the HARQ feedback occasion (base station temporarily resumes reception during part of network DRX duration which overlaps with HARQ feedback occasion)
   Starts the drx-HARQ-RTT-TimerDL for the corresponding HARQ process in the first symbol after the end of the corresponding transmission carrying the DL HARQ feedback;
   Stop the drx-Retransmission TimerDL for the corresponding HARQ process.
   if a drx-HARQ-RTT-TimerDL expires:
      if the data of the corresponding HARQ process was not successfully decoded (i.e., HARQ NACK is rcvd):
         Start the drx-RetransmissionTimerDL for the corresponding HARQ process in the first symbol after the expiry of drx-HARQ-RTT-TimerDL.
Cell on which HARQ feedback is to be received from a UE can be same as or can be different from the cell in which DL/PDSCH transmission indicated by PDCCH or configured downlink assignment is transmitted; HARQ feedback is received on SpCell or PUCCH SCell, DL transmission can be on SpCell or PUCCH SCell or any other SCell. PDCCH indicating DL transmission can be transmitted from a cell same or different from the cell on which indicated DL/PDSCH transmission is transmitted to the UE.

In an embodiment, network DRX duration in above description can be the cell level inactive duration where cell does not receive any transmission from a UE or does not receive any dedicated transmission from the UE or does not receive certain transmissions (e.g., PUCCH/PUSCH) from the UE.

### [Method 1-1: Sidelink Aspects]

A UE (or MAC entity in the UE) receives PDCCH indicating a SL transmission (i.e., resources for SL transmission) or a MAC PDU is transmitted in a configured sidelink grant:
If PUCCH resources is configured:
   If HARQ feedback occasion for transmitting the SL HARQ feedback over PUCCH overlaps (partially or fully) with network DRX duration (i.e., cell level DRX duration of cell on which HARQ feedback is to be transmitted):
      Instead of skipping the SL HARQ feedback, a UE or (MAC entity in the UE) transmits SL HARQ feedback in HARQ feedback occasion to gNB;
      A UE or (MAC entity in the UE) starts the drx-HARQ-RTT-TimerSL for the corresponding HARQ process in the first symbol after the end of the corresponding PUCCH transmission carrying the SL HARQ feedback;
      A UE or (MAC entity in the UE stops the drx-Retransmission TimerSL for the corresponding HARQ process.
   Else (non overlapping case):
      A UE or (MAC entity in the UE) transmits SL HARQ feedback in HARQ feedback occasion. The UE or (MAC entity in the UE) starts the drx-HARQ-RTT-TimerSL for the corresponding HARQ process in the first symbol after the end of the corresponding PUCCH transmission carrying the SL HARQ feedback; the UE or (MAC entity in the UE) stops the drx-Retransmission TimerSL for the corresponding HARQ process.
Else (PUCCH resources is not configured)
   start the drx-HARQ-RTT-TimerSL for the corresponding HARQ process at the first symbol after the end of the corresponding physical sidelink shared channel (PSSCH) transmission;
   stop the drx-Retransmission TimerSL for the corresponding HARQ process.
if a drx-HARQ-RTT-TimerSL expires:
   if a HARQ NACK feedback for the corresponding HARQ process is transmitted on PUCCH; or
   if a HARQ NACK feedback for the corresponding HARQ process is not transmitted on PUCCH; or
   if the PUCCH resource is not configured for the SL grant:
      start the drx-Retransmission TimerSL for the corresponding HARQ process in the first symbol after the expiry of drx-HARQ-RTT-TimerSL.

### [Method 1A]

A UE is in a RRC_CONNECTED state. The UE is configured with connected mode DRX configuration (as described earlier) using RRC signaling. For network energy savings, Cell DTX and/or Cell DRX can be configured wherein periodic cell DTX/DRX pattern is configured by UE-specific RRC signaling message. Cell DTX and Cell DRX modes can be configured and operated separately (e.g., one RRC configuration set for DL and the other set for UL). The UE specific DRX can be configured in a cell supporting Cell DTX and/or Cell DRX.

Periodic cell DTX pattern may be configured by a ‘duration’ and ‘period’ field wherein during the ‘duration’ interval which occurs periodically every ‘period,”,” cell does not perform transmission (or stops certain transmissions (e.g., PDSCH, PBCH, SSBs, etc.). Alternately, periodic cell DTX pattern may be configured by a ‘duration’ and ‘period’ field wherein during the ‘duration’ interval which occurs periodically every ‘period, ”,” cell perform transmission and during the interval ‘period-duration’ cell does not perform transmission (or stops certain transmissions (e.g., PDSCH, PBCH, SSBs, etc.)).

Periodic cell DRX pattern may be configured by a ‘duration’ and ‘period’ field wherein during the ‘duration’ interval which occurs periodically every ‘period, ”,” cell does not perform reception (or stops certain receptions e.g., PUCCH, PUSCH, PRACH etc.). Alternately, periodic cell DRX pattern may be configured by a ‘duration’ and ‘period’ field wherein during the ‘duration’ interval which occurs periodically every ‘period,” cell perform reception and during the interval “period-duration” cell does not perform reception (or stops certain receptions e.g., PUCCH, PUSCH, PRACH etc.). During the cell level DRX duration where a network (i.e., base station) does not receive transmission (or certain transmissions) from the UE on the uplink of that cell, the UE does not transmit (or does not transmit) certain transmissions in uplink of that cell.

A UE (or MAC entity in the UE) receives PDCCH indicating a DL/PDSCH transmission (i.e., resources for DL/PDSCH transmission) or the UE receives a MAC PDU in a configured downlink assignment (indicated by configured grant type 1 or configured grant type 2 configuration indicating periodic resources for DL/PDSCH transmission) for unicast:
If HARQ feedback occasion for transmitting the DL HARQ feedback for the DL/PDSCH transmission (indicated by PDCCH or configured downlink assignment) overlaps (partially or fully) with network DRX duration (i.e., cell level DRX duration of cell on which HARQ feedback is to be transmitted; this can be same as or can be different from the cell in which DL/PDSCH transmission indicated by PDCCH or configured downlink assignment is received; HARQ feedback is transmitted on SpCell or PUCCH SCell, DL transmission can be on SpCell or PUCCH SCell or any other SCell):
   If a network configures (e.g., the network can send an indication in RRC signaling or PDCCH/DCI or system information, the indication can be per cell or per cell group or per BWP and the UE applies the indication accordingly) that the UE transmits HARQ feedback in HARQ feedback occasion of cell during network DRX duration (of that cell):
      Instead of skipping the DL HARQ feedback, the UE or (MAC entity in the UE) transmits DL HARQ feedback in HARQ feedback occasion;
      A UE or (MAC entity in the UE) starts the drx-HARQ-RTT-TimerDL for the corresponding HARQ process in the first symbol after the end of the corresponding transmission carrying the DL HARQ feedback;
      A UE or (MAC entity in the UE) stops the drx-Retransmission TimerDL for the corresponding HARQ process.
   Else:
      A UE (or MAC entity in the UE) skips the DL HARQ feedback transmission in HARQ feedback occasion which overlaps (partially or fully) with network DRX duration.
Else (non overlapping case):
   A UE or (MAC entity in the UE) transmits DL HARQ feedback in HARQ feedback occasion. The UE or (MAC entity in the UE) starts the drx-HARQ-RTT-TimerDL for the corresponding HARQ process in the first symbol after the end of the corresponding transmission carrying the DL HARQ feedback; the UE or (MAC entity in the UE) stops the drx-Retransmission TimerDL for the corresponding HARQ process.
if a drx-HARQ-RTT-TimerDL expires:
   if the data of the corresponding HARQ process was not successfully decoded:
      start the drx-RetransmissionTimerDL for the corresponding HARQ process in the first symbol after the expiry of drx-HARQ-RTT-TimerDL.
Cell on which HARQ feedback is to be transmitted by the UE can be same as or can be different from the cell in which DL/PDSCH transmission indicated by PDCCH or configured downlink assignment is received; HARQ feedback is transmitted on SpCell or PUCCH SCell, DL transmission can be on SpCell or PUCCH SCell or any other SCell. PDCCH indicating DL transmission can be received from a cell same or different from the cell on which indicated DL/PDSCH transmission is received by the UE.

Base station configures cell specific DRX for one or more serving cells. During the cell level DRX duration of a cell, a network (i.e., base station) does not receive transmission (or certain transmissions) from the UE on the uplink of that cell.

Base station transmits PDCCH indicating resources for DL transmission. Base station transmits DL TB in indicated resources (these resources are PDSCH resources of a cell). Resources for DL transmission can also be a configured downlink assignment (configured grant type 1 or configured grant type 2) for unicast.
Upon transmitting the DL TB, HARQ feedback is expected from the UE in HARQ feedback occasion corresponding to the DL TB.
HARQ feedback occasion for receiving the DL HARQ feedback for the DL transmission (indicated by PDCCH or configured downlink assignment) overlaps (partially or fully) with network DRX duration (i.e., cell level DRX duration of cell on which HARQ feedback is to be received):
   If a network configures (e.g., the network can send an indication in RRC signaling or PDCCH/DCI or system information, the indication can be per cell or per cell group or per BWP and the UE applies the indication accordingly) that the UE transmits HARQ feedback in HARQ feedback occasion of cell during network DRX duration (of that cell):

Instead of skipping the reception of DL HARQ feedback in the HARQ feedback occasion, base station receives DL HARQ feedback in the HARQ feedback occasion (base station temporarily resumes reception during part of network DRX duration which overlaps with HARQ feedback occasion);
starts the drx-HARQ-RTT-TimerDL for the corresponding HARQ process in the first symbol after the end of the corresponding transmission carrying the DL HARQ feedback;
Stop the drx-RetransmissionTimerDL for the corresponding HARQ process.
if a drx-HARQ-RTT-TimerDL expires:
   if the data of the corresponding HARQ process was not successfully decoded (i.e., HARQ NACK is received):
      start the drx-RetransmissionTimerDL for the corresponding HARQ process in the first symbol after the expiry of drx-HARQ-RTT-TimerDL.
Else:
   Base station skips the reception of DL HARQ feedback in the HARQ feedback occasion which overlaps (partially or fully) with network DRX duration
Cell on which HARQ feedback is to be received from the UE can be same as or can be different from the cell in which DL/PDSCH transmission indicated by PDCCH or configured downlink assignment is transmitted; HARQ feedback is received on SpCell or PUCCH SCell, DL transmission can be on SpCell or PUCCH SCell or any other SCell. PDCCH indicating DL transmission can be transmitted from a cell same or different from the cell on which indicated DL/PDSCH transmission is transmitted to the UE.

In an embodiment, network DRX duration in above description can be the cell level inactive duration where cell does not receive any transmission from the UE or does not receive any dedicated transmission from the UE or does not receive certain transmissions (e.g., PUCCH/PUSCH) from the UE.

### [Method 1A-1: Sidelink Aspects]

A UE (or MAC entity in the UE) receives PDCCH indicating a SL transmission (i.e., resources for SL transmission) or a MAC PDU is transmitted in a configured sidelink grant:
If PUCCH resources is configured:
   If HARQ feedback occasion for transmitting the SL HARQ feedback over PUCCH overlaps (partially or fully) with network DRX duration (i.e., cell level DRX duration of cell on which HARQ feedback is to be transmitted):
      If a network configures (e.g., the network can send an indication in RRC signaling or PDCCH/DCI or system information, the indication can be per cell or per cell group or per BWP and the UE applies the indication accordingly) that the UE transmits HARQ feedback in HARQ feedback occasion of cell during network DRX duration (of that cell):
Instead of skipping the SL HARQ feedback, the UE or (MAC entity in the UE) transmits SL HARQ feedback in HARQ feedback occasion to gNB;
A UE or (MAC entity in the UE) starts the drx-HARQ-RTT-TimerSL for the corresponding HARQ process in the first symbol after the end of the corresponding PUCCH transmission carrying the SL HARQ feedback;
A UE or (MAC entity in the UE stops the drx-Retransmission TimerSL for the corresponding HARQ process.
Else:
   A UE or (MAC entity in the UE) does not transmit SL HARQ feedback in HARQ feedback occasion to gNB
Else (non overlapping case):
   A UE or (MAC entity in the UE) transmits SL HARQ feedback in HARQ feedback occasion. The UE or (MAC entity in the UE) starts the drx-HARQ-RTT-TimerSL for the corresponding HARQ process in the first symbol after the end of the corresponding PUCCH transmission carrying the SL HARQ feedback; the UE or (MAC entity in the UE) stops the drx-RetransmissionTimerSL for the corresponding HARQ process.
Else (PUCCH resources is not configured):
   start the drx-HARQ-RTT-TimerSL for the corresponding HARQ process at the first symbol after the end of the corresponding PSSCH transmission;
   stop the drx-RetransmissionTimerSL for the corresponding HARQ process.
if a drx-HARQ-RTT-TimerSL expires:
   if a HARQ NACK feedback for the corresponding HARQ process is transmitted on PUCCH; or
   if a HARQ NACK feedback for the corresponding HARQ process is not transmitted on PUCCH; or
   if the PUCCH resource is not configured for the SL grant:
      start the drx-RetransmissionTimerSL for the corresponding HARQ process in the first symbol after the expiry of drx-HARQ-RTT-TimerSL.

### [Method 2]

FIG. 5 illustrates another example of PDCCH reception with respect to overlap of network DRX duration and HARQ feedback occasion in accordance with an embodiment of the present disclosure.

A UE is in a RRC_CONNECTED state. The UE is configured with connected mode DRX configuration (as described earlier) using RRC signaling. For network energy savings, cell DTX and/or cell DRX can be configured wherein periodic cell DTX/DRX pattern is configured by UE-specific RRC signaling message. Cell DTX and cell DRX modes can be configured and operated separately (e.g., one RRC configuration set for DL and the other set for UL). The UE specific DRX can be configured in a cell supporting cell DTX and/or cell DRX.

Periodic cell DTX pattern may be configured by a “duration” and “period” field wherein during the “duration” interval which occurs periodically every “period,” cell does not perform transmission (or stops certain transmissions (e.g., PDSCH, PBCH, SSBs, etc.). Alternately, periodic cell DTX pattern may be configured by a “duration” and “period” field wherein during the “duration” interval which occurs periodically every “period,” cell perform transmission and during the interval “period-duration” cell does not perform transmission (or stops certain transmissions (e.g., PDSCH, PBCH, SSBs, etc.)).

Periodic cell DRX pattern may be configured by a “duration” and “period” field wherein during the “duration” interval which occurs periodically every “period,” cell does not perform reception (or stops certain receptions e.g., PUCCH, PUSCH, PRACH etc.). Alternately, periodic cell DRX pattern may be configured by a “duration” and “period” field wherein during the “duration” interval which occurs periodically every “period,” cell perform reception and during the interval “period-duration” cell does not perform reception (or stops certain receptions e.g., PUCCH, PUSCH, PRACH etc.). During the cell level DRX duration where a network (i.e., base station) does not receive transmission (or certain transmissions) from the UE on the uplink of that cell, the UE does not transmit (or does not transmit) certain transmissions in uplink of that cell.

A UE (or MAC entity in the UE) receives PDCCH indicating a DL/PDSCH transmission (i.e., resources for DL/PDSCH transmission) or the UE receives a MAC PDU in a configured downlink assignment (indicated by configured grant type 1 or configured grant type 2 configuration indicating periodic resources for DL/PDSCH transmission) for unicast (as shown in FIG. 5):
If HARQ feedback occasion for transmitting the DL HARQ feedback for the DL/PDSCH transmission (indicated by PDCCH or configured downlink assignment) overlaps (partially or fully) with network DRX duration (i.e., cell level DRX duration of cell on which HARQ feedback is to be transmitted (510); this can be same as or can be different from the cell in which DL/PDSCH transmission indicated by PDCCH or configured downlink assignment is received; HARQ feedback is transmitted on SpCell or PUCCH SCell, DL transmission can be on SpCell or PUCCH Scell or any other Scell):
   A UE or (MAC entity in the UE) does not transmit DL HARQ feedback in HARQ feedback occasion (520);
   A UE or (MAC entity in the UE) starts the drx-Retransmission TimerDL for the corresponding HARQ process in the first symbol after the end of the corresponding DL/PDSCH reception (or in the first symbol at an offset after the end of the corresponding DL/PDSCH reception, where offset is pre-defined or signalled by base station in RRC signaling or system info) (530);
Else:
   A UE or (MAC entity in the UE) transmits DL HARQ feedback in HARQ feedback occasion;
   A UE or (MAC entity in the UE) starts the drx-HARQ-RTT-TimerDL for the corresponding HARQ process in the first symbol after the end of the corresponding transmission carrying the DL HARQ feedback;
   Stop the drx-RetransmissionTimerDL for the corresponding HARQ process.
   if a drx-HARQ-RTT-TimerDL expires:
      if the data of the corresponding HARQ process was not successfully decoded:
         start the drx-RetransmissionTimerDL for the corresponding HARQ process in the first symbol after the expiry of drx-HARQ-RTT-TimerDL.
Cell on which HARQ feedback is to be transmitted by the UE can be same as or can be different from the cell in which DL/PDSCH transmission indicated by PDCCH or configured downlink assignment is received; HARQ feedback is transmitted on SpCell or PUCCH Scell, DL transmission can be on SpCell or PUCCH Scell or any other Scell. PDCCH indicating DL transmission can be received from a cell same or different from the cell on which indicated DL/PDSCH transmission is received by the UE.

Base station configures cell specific DRX for one or more serving cells. During the cell level DRX duration of a cell, a network (i.e., base station) does not receive transmission (or certain transmissions) from a UE on the uplink of that cell.

Base station transmits PDCCH indicating resources for DL transmission. Base station transmits DL TB in indicated resources (these resources are PDSCH resources of a cell). Resources for DL transmission can also be a configured downlink assignment (indicated by configured grant type 1 or configured grant type 2 configuration indicating periodic resources for DL/PDSCH transmission) for unicast.
Upon transmitting the DL TB, HARQ feedback is expected from a UE in HARQ feedback occasion corresponding to the DL TB.
If HARQ feedback occasion for receiving the DL HARQ feedback for the DL transmission (indicated by PDCCH or configured downlink assignment) overlaps (partially or fully) with network DRX duration (i.e., cell level DRX duration of cell on which HARQ feedback is to be received):
   Skip the reception of DL HARQ feedback in the HARQ feedback occasion;
   starts the drx-RetransmissionTimerDL for the corresponding HARQ process in the first symbol after the end of the corresponding DL/PDSCH reception (or in the first symbol at an offset after the end of the corresponding DL/PDSCH reception, where offset is signalled by base station in RRC signaling or system info).
Else:
   Receive DL HARQ feedback in the HARQ feedback occasion;
   starts the drx-HARQ-RTT-TimerDL for the corresponding HARQ process in the first symbol after the end of the HARQ feedback occasion carrying the DL HARQ feedback;
   Stop the drx-Retransmission TimerDL for the corresponding HARQ process.
   if a drx-HARQ-RTT-TimerDL expires:
      if the data of the corresponding HARQ process was not successfully decoded (i.e., HARQ NACK is received):
Start the drx-Retransmission TimerDL for the corresponding HARQ process in the first symbol after the expiry of drx-HARQ-RTT-TimerDL.
Cell on which HARQ feedback is to be received from a UE can be same as or can be different from the cell in which DL/PDSCH transmission indicated by PDCCH or configured downlink assignment is transmitted; HARQ feedback is received on SpCell or PUCCH Scell, DL transmission can be on SpCell or PUCCH Scell or any other Scell. PDCCH indicating DL transmission can be transmitted from a cell same or different from the cell on which indicated DL/PDSCH transmission is transmitted to the UE.

In an embodiment, network DRX duration in above description can be the cell level inactive duration where cell does not receive any transmission from a UE or does not receive any dedicated transmission from the UE or does not receive certain transmissions (e.g., PUCCH/PUSCH) from the UE.

### [Method 2-1: Sidelink Aspects]

A UE (or MAC entity in the UE) receives PDCCH indicating a SL transmission (i.e., resources for SL transmission) or a MAC PDU is transmitted in a configured sidelink grant:
If PUCCH resources is configured:
   If HARQ feedback occasion for transmitting the SL HARQ feedback over PUCCH overlaps (partially or fully) with network DRX duration (i.e., cell level DRX duration of cell on which HARQ feedback is to be transmitted):
      A UE or (MAC entity in the UE) does not transmit SL HARQ feedback in HARQ feedback occasion;
      A UE or (MAC entity in the UE) starts the drx-Retransmission TimerSL for the corresponding HARQ process in the first symbol after the end of the corresponding PSSCH transmission (or in the first symbol at an offset after the end of the corresponding PSSCH transmission, where offset is pre-defined or signalled by base station in RRC signaling or system info);
   Else (non overlapping case):
      A UE or (MAC entity in the UE) transmits SL HARQ feedback in HARQ feedback occasion. The UE or (MAC entity in the UE) starts the drx-HARQ-RTT-TimerSL for the corresponding HARQ process in the first symbol after the end of the corresponding PUCCH transmission carrying the SL HARQ feedback; the UE or (MAC entity in the UE) stops the drx-RetransmissionTimerSL for the corresponding HARQ process.
Else (PUCCH resources is not configured):
   start the drx-HARQ-RTT-TimerSL for the corresponding HARQ process at the first symbol after the end of the corresponding PSSCH transmission;
   stop the drx-Retransmission TimerSL for the corresponding HARQ process.
if a drx-HARQ-RTT-TimerSL expires:
   if a HARQ NACK feedback for the corresponding HARQ process is transmitted on PUCCH; or
   if a HARQ NACK feedback for the corresponding HARQ process is not transmitted on PUCCH; or
   if the PUCCH resource is not configured for the SL grant:
      start the drx-Retransmission TimerSL for the corresponding HARQ process in the first symbol after the expiry of drx-HARQ-RTT-TimerSL.

### [Method 2A]

A UE is in a RRC_CONNECTED state. The UE is configured with connected mode DRX configuration (as described earlier) using RRC signaling. For network energy savings, cell DTX and/or cell DRX can be configured wherein periodic cell DTX/DRX pattern is configured by UE-specific RRC signaling message. Cell DTX and Cell DRX modes can be configured and operated separately (e.g., one RRC configuration set for DL and the other set for UL). The UE specific DRX can be configured in a cell supporting cell DTX and/or Cell DRX.

Periodic cell DTX pattern may be configured by a “duration” and “period” field wherein during the “duration” interval which occurs periodically every “period,” cell does not perform transmission (or stops certain transmissions (e.g., PDSCH, PBCH, SSBs, etc.). Alternately, periodic cell DTX pattern may be configured by a “duration” and “period” field wherein during the “duration” interval which occurs periodically every “period,” cell perform transmission and during the interval “period-duration” cell does not perform transmission (or stops certain transmissions (e.g., PDSCH, PBCH, SSBs, etc.)).

Periodic cell DRX pattern may be configured by a “duration” and “period” field wherein during the “duration” interval which occurs periodically every “period,” cell does not perform reception (or stops certain receptions e.g., PUCCH, PUSCH, PRACH etc.). Alternately, periodic cell DRX pattern may be configured by a “duration” and “period” field wherein during the “duration” interval which occurs periodically every “period,” cell perform reception and during the interval “period-duration” cell does not perform reception (or stops certain receptions e.g., PUCCH, PUSCH, PRACH etc.). During the cell level DRX duration where a network (i.e., base station) does not receive transmission (or certain transmissions) from a UE on the uplink of that cell, the UE does not transmit (or does not transmit) certain transmissions in uplink of that cell.

A UE (or MAC entity in the UE) receives PDCCH indicating a DL/PDSCH transmission (i.e., resources for DL/PDSCH transmission) or the UE receives a MAC PDU in a configured downlink assignment (configured grant type 1 or configured grant type 2 indicating periodic resources for DL/PDSCH transmission) for unicast:
If HARQ feedback occasion for transmitting the DL HARQ feedback for the DL/PDSCH transmission (indicated by PDCCH or configured downlink assignment) overlaps (partially or fully) with network DRX duration (i.e., cell level DRX duration of cell on which HARQ feedback is to be transmitted; this can be same as or can be different from the cell in which DL/PDSCH transmission indicated by PDCCH or configured downlink assignment is received; HARQ feedback is transmitted on SpCell or PUCCH SCell, DL transmission can be on SpCell or PUCCH SCell or any other SCell):
   A UE or (MAC entity in the UE) does not transmit DL HARQ feedback in HARQ feedback occasion;
   If a network configures (e.g., the network can send an indication in RRC signaling or PDCCH/DCI or system information, the indication can be per cell or per cell group or per BWP and a UE applies the indication accordingly) that the UE starts drx-Retransmission TimerDL in the first symbol after the end of PDSCH transmission (of that cell) in case of overlapping (or if the network indicates/configures enhanced DRX operation for NES):
      A UE or (MAC entity in the UE) starts the drx-Retransmission TimerDL for the corresponding HARQ process in the first symbol after the end of the corresponding DL/PDSCH reception (or in the first symbol at an offset after the end of the corresponding DL/PDSCH reception, where offset is signalled by base station in RRC signaling or system info);
Else:
   A UE or (MAC entity in the UE) transmits DL HARQ feedback in HARQ feedback occasion;
   A UE or (MAC entity in the UE) starts the drx-HARQ-RTT-TimerDL for the corresponding HARQ process in the first symbol after the end of the corresponding transmission carrying the DL HARQ feedback;
   Stop the drx-RetransmissionTimerDL for the corresponding HARQ process.
   if a drx-HARQ-RTT-TimerDL expires:
      if the data of the corresponding HARQ process was not successfully decoded:
   start the drx-RetransmissionTimerDL for the corresponding HARQ process in the first symbol after the expiry of drx-HARQ-RTT-TimerDL.
Cell on which HARQ feedback is to be transmitted by a UE can be same as or can be different from the cell in which DL/PDSCH transmission indicated by PDCCH or configured downlink assignment is received; HARQ feedback is transmitted on SpCell or PUCCH SCell, DL transmission can be on SpCell or PUCCH SCell or any other SCell. PDCCH indicating DL transmission can be received from a cell same or different from the cell on which indicated DL/PDSCH transmission is received by the UE.

Base station configures cell specific DRX for one or more serving cells. During the cell level DRX duration of a cell, a network (i.e., base station) does not receive transmission (or certain transmissions) from a UE on the uplink of that cell.

Base station transmits PDCCH indicating resources for DL transmission. Base station transmits DL TB in indicated resources (these resources are PDSCH resources of a cell). Resources for DL transmission can also be a configured downlink assignment (indicated by configured grant type 1 or configured grant type 2 configuration indicating periodic resources for DL/PDSCH transmission) for unicast.
Upon transmitting the DL TB, HARQ feedback is expected from a UE in HARQ feedback occasion corresponding to the DL TB.
If HARQ feedback occasion for receiving the DL HARQ feedback for the DL transmission (indicated by PDCCH or configured downlink assignment) overlaps (partially or fully) with network DRX duration (i.e., cell level DRX duration of cell on which HARQ feedback is to be received);
   Skip the reception of DL HARQ feedback in the HARQ feedback occasion;
   If a network configures (e.g., the network can send an indication in RRC signaling or PDCCH/DCI or system information, the indication can be per cell or per cell group or per BWP and a UE applies the indication accordingly) that the UE starts drx-RetransmissionTimerDL in the first symbol after the end of PDSCH transmission (of that cell) in case of overlapping (or if the network indicates/configures enhanced DRX operation for NES):
      starts the drx-Retransmission TimerDL for the corresponding HARQ process in the first symbol after the end of the corresponding DL/PDSCH transmission (or in the first symbol at an offset after the end of the corresponding DL/PDSCH transmission, where offset is signalled by base station in RRC signaling or system info);
Else:
   Receive DL HARQ feedback in the HARQ feedback occasion;
Cell on which HARQ feedback is to be received from a UE can be same as or can be different from the cell in which DL/PDSCH transmission indicated by PDCCH or configured downlink assignment is transmitted; HARQ feedback is received on SpCell or PUCCH SCell, DL transmission can be on SpCell or PUCCH SCell or any other SCell. PDCCH indicating DL transmission can be transmitted from a cell same or different from the cell on which indicated DL/PDSCH transmission is transmitted to the UE.

In an embodiment, network DRX duration in above description can be the cell level inactive duration where cell does not receive any transmission from a UE or does not receive any dedicated transmission from the UE or does not receive certain transmissions (e.g., PUCCH/PUSCH) from the UE.

### [Method 2A-1: Sidelink Aspects]

A UE (or MAC entity in the UE) receives PDCCH indicating a SL transmission (i.e., resources for SL transmission) or a MAC PDU is transmitted in a configured sidelink grant:
If PUCCH resources is configured:
   If HARQ feedback occasion for transmitting the SL HARQ feedback over PUCCH overlaps (partially or fully) with network DRX duration (i.e., cell level DRX duration of cell on which HARQ feedback is to be transmitted):
      A UE or (MAC entity in the UE) does not transmit SL HARQ feedback in HARQ feedback occasion;
      If a network configures (e.g., the network can send an indication in RRC signaling or PDCCH/DCI or system information, the indication can be per cell or per cell group or per BWP and a UE applies the indication accordingly) that the UE starts drx-RetransmissionTimerSL in the first symbol after the end of PSSCH transmission in case of overlapping (or if the network indicates/configures enhanced DRX operation for NES):
         A UE or (MAC entity in the UE) starts the drx-Retransmission TimerSL for the corresponding HARQ process in the first symbol after the end of the corresponding PSSCH transmission (or in the first symbol at an offset after the end of the corresponding PSSCH transmission, where offset is pre-defined or signalled by base station in RRC signaling or system info);
   Else (non overlapping case):
      A UE or (MAC entity in the UE) transmits SL HARQ feedback in HARQ feedback occasion. The UE or (MAC entity in the UE) starts the drx-HARQ-RTT-TimerSL for the corresponding HARQ process in the first symbol after the end of the corresponding PUCCH transmission carrying the SL HARQ feedback; the UE or (MAC entity in the UE) stops the drx-Retransmission TimerSL for the corresponding HARQ process.
Else (PUCCH resources is not configured):
   start the drx-HARQ-RTT-TimerSL for the corresponding HARQ process at the first symbol after the end of the corresponding PSSCH transmission;
   stop the drx-RetransmissionTimerSL for the corresponding HARQ process.
if a drx-HARQ-RTT-TimerSL expires:
   if a HARQ NACK feedback for the corresponding HARQ process is transmitted on PUCCH; or
   if a HARQ NACK feedback for the corresponding HARQ process is not transmitted on PUCCH; or
   if the PUCCH resource is not configured for the SL grant:
      start the drx-RetransmissionTimerSL for the corresponding HARQ process in the first symbol after the expiry of drx-HARQ-RTT-TimerSL.

### [Method 3]

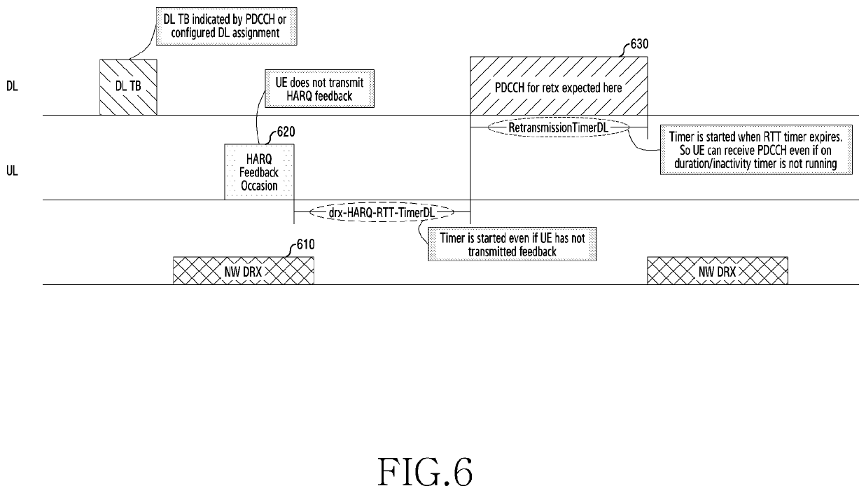

FIG. 6 illustrates another example of PDCCH reception with respect to overlap of network DRX duration and HARQ feedback occasion in accordance with an embodiment of the present disclosure.

A UE is in a RRC_CONNECTED state. The UE is configured with connected mode DRX configuration (as described earlier) using RRC signaling. For network energy savings, Cell DTX and/or Cell DRX can be configured wherein periodic cell DTX/DRX pattern is configured by UE-specific RRC signaling message. Cell DTX and Cell DRX modes can be configured and operated separately (e.g., one RRC configuration set for DL and the other set for UL). The UE specific DRX can be configured in a cell supporting Cell DTX and/or Cell DRX.

Periodic cell DTX pattern may be configured by a “duration” and “period” field wherein during the “duration” interval which occurs periodically every “period,” cell does not perform transmission (or stops certain transmissions (e.g., PDSCH, PBCH, SSBs, etc.). Alternately, periodic cell DTX pattern may be configured by a “duration” and “period” field wherein during the “duration” interval which occurs periodically every “period,” cell perform transmission and during the interval “period-duration” cell does not perform transmission (or stops certain transmissions (e.g., PDSCH, PBCH, SSBs, etc.)).

Periodic cell DRX pattern may be configured by a “duration” and “period” field wherein during the “duration” interval which occurs periodically every “period,” cell does not perform reception (or stops certain receptions e.g., PUCCH, PUSCH, PRACH etc.). Alternately, periodic cell DRX pattern may be configured by a “duration” and “period” field wherein during the “duration” interval which occurs periodically every “period,” cell perform reception and during the interval “period-duration” cell does not perform reception (or stops certain receptions e.g., PUCCH, PUSCH, PRACH etc.). During the cell level DRX duration where a network (i.e., base station) does not receive transmission (or certain transmissions) from a UE on the uplink of that cell, the UE does not transmit (or does not transmit) certain transmissions in uplink of that cell.

A UE (or MAC entity in the UE) receives PDCCH indicating a DL/PDSCH transmission (i.e., resources for DL/PDSCH transmission) or the UE receives a MAC PDU in a configured downlink assignment (indicated by configured grant type 1 or configured grant type 2 configuration indicating periodic resources for DL/PDSCH transmission) for unicast (as shown in FIG. 6):
If HARQ feedback occasion for transmitting the DL HARQ feedback for the DL/PDSCH transmission (indicated by PDCCH or configured downlink assignment) overlaps (partially or fully) with network DRX duration (i.e., cell level DRX duration of cell on which HARQ feedback is to be transmitted (610); this can be same as or can be different from the cell in which DL/PDSCH transmission indicated by PDCCH or configured downlink assignment is received; HARQ feedback is transmitted on SpCell or PUCCH Scell, DL transmission can be on SpCell or PUCCH Scell or any other Scell):
   A UE or (MAC entity in the UE) does not transmit DL HARQ feedback in HARQ feedback occasion (620);
   A UE or (MAC entity in the UE) starts the drx-HARQ-RTT-TimerDL for the corresponding HARQ process in the first symbol after the end of the HARQ feedback occasion
   if a drx-HARQ-RTT-TimerDL expires:
      if the data of the corresponding HARQ process was not successfully decoded:
         start the drx-RetransmissionTimerDL for the corresponding HARQ process in the first symbol after the expiry of drx-HARQ-RTT-TimerDL (630).
Else:
   A UE or (MAC entity in the UE) transmits DL HARQ feedback in HARQ feedback occasion;
   A UE or (MAC entity in the UE) starts the drx-HARQ-RTT-TimerDL for the corresponding HARQ process in the first symbol after the end of the corresponding transmission carrying the DL HARQ feedback;
   Stop the drx-RetransmissionTimerDL for the corresponding HARQ process.
   if a drx-HARQ-RTT-TimerDL expires:
      if the data of the corresponding HARQ process was not successfully decoded:
start the drx-Retransmission TimerDL for the corresponding HARQ process in the first symbol after the expiry of drx-HARQ-RTT-TimerDL.
Cell on which HARQ feedback is to be transmitted by a UE can be same as or can be different from the cell in which DL/PDSCH transmission indicated by PDCCH or configured downlink assignment is received; HARQ feedback is transmitted on SpCell or PUCCH Scell, DL transmission can be on SpCell or PUCCH Scell or any other Scell. PDCCH indicating DL transmission can be received from a cell same or different from the cell on which indicated DL/PDSCH transmission is received by the UE.

Base station configures cell specific DRX for one or more serving cells. During the cell level DRX duration of a cell, a network (i.e., base station) does not receive transmission (or certain transmissions) from a UE on the uplink of that cell.

Base station transmits PDCCH indicating resources for DL transmission. Base station transmits DL TB in indicated resources (these resources are PDSCH resources of a cell). Resources for DL transmission can also be a configured downlink assignment (indicated by configured grant type 1 or configured grant type 2 configuration indicating periodic resources for DL/PDSCH transmission) for unicast.
Upon transmitting the DL TB, HARQ feedback is expected from a UE in HARQ feedback occasion corresponding to the DL TB.
If HARQ feedback occasion for receiving the DL HARQ feedback for the DL transmission (indicated by PDCCH or configured downlink assignment) overlaps (partially or fully) with network DRX duration (i.e., cell level DRX duration of cell on which HARQ feedback is to be received):
   Skip the reception of DL HARQ feedback in the HARQ feedback occasion;
   starts the drx-HARQ-RTT-TimerDL for the corresponding HARQ process in the first symbol after the end of the HARQ feedback occasion;
   if a drx-HARQ-RTT-TimerDL expires:
      start the drx-RetransmissionTimerDL for the corresponding HARQ process in the first symbol after the expiry of drx-HARQ-RTT-TimerDL.
Else:
   Receive DL HARQ feedback in the HARQ feedback occasion;
   starts the drx-HARQ-RTT-TimerDL for the corresponding HARQ process in the first symbol after the end of HARQ feedback occasion carrying the DL HARQ feedback;
   Stop the drx-RetransmissionTimerDL for the corresponding HARQ process.
   if a drx-HARQ-RTT-TimerDL expires:
      start the drx-Retransmission TimerDL for the corresponding HARQ process in the first symbol after the expiry of drx-HARQ-RTT-TimerDL.
Cell on which HARQ feedback is to be received from a UE can be same as or can be different from the cell in which DL/PDSCH transmission indicated by PDCCH or configured downlink assignment is transmitted; HARQ feedback is received on SpCell or PUCCH Scell, DL transmission can be on SpCell or PUCCH Scell or any other Scell. PDCCH indicating DL transmission can be transmitted from a cell same or different from the cell on which indicated DL/PDSCH transmission is transmitted to the UE.

In an embodiment, network DRX duration in above description can be the cell level inactive duration where cell does not receive any transmission from a UE or does not receive any dedicated transmission from the UE or does not receive certain transmissions (e.g., PUCCH/PUSCH) from the UE.

### [Method 3-1: Sidelink Aspects]

A UE (or MAC entity in the UE) receives PDCCH indicating a SL transmission (i.e., resources for SL transmission) or a MAC PDU is transmitted in a configured sidelink grant:
If PUCCH resources is configured:
   If HARQ feedback occasion for transmitting the SL HARQ feedback over PUCCH overlaps (partially or fully) with network DRX duration (i.e., cell level DRX duration of cell on which HARQ feedback is to be transmitted):
      A UE or (MAC entity in the UE) does not transmit SL HARQ feedback in HARQ feedback occasion
      A UE or (MAC entity in the UE) starts the drx-HARQ-RTT-TimerSL for the corresponding HARQ process in the first symbol after the end of the HARQ feedback occasion for SL HARQ feedback over PUCCH; the UE or (MAC entity in the UE) stops the drx-Retransmission TimerSL for the corresponding HARQ process.
   Else (non overlapping case):
      A UE or (MAC entity in the UE) transmits SL HARQ feedback in HARQ feedback occasion. The UE or (MAC entity in the UE) starts the drx-HARQ-RTT-TimerSL for the corresponding HARQ process in the first symbol after the end of the corresponding PUCCH transmission carrying the SL HARQ feedback; the UE or (MAC entity in the UE) stops the drx-Retransmission TimerSL for the corresponding HARQ process.
Else (PUCCH resources is not configured):
   start the drx-HARQ-RTT-TimerSL for the corresponding HARQ process at the first symbol after the end of the corresponding PSSCH transmission;
   stop the drx-Retransmission TimerSL for the corresponding HARQ process.
if a drx-HARQ-RTT-TimerSL expires:
   if a HARQ NACK feedback for the corresponding HARQ process is transmitted on PUCCH; or
   if a HARQ NACK feedback for the corresponding HARQ process is not transmitted on PUCCH; or
   if the PUCCH resource is not configured for the SL grant:
      start the drx-RetransmissionTimerSL for the corresponding HARQ process in the first symbol after the expiry of drx-HARQ-RTT-TimerSL.

### [Method 3A]

A UE is in a RRC_CONNECTED state. The UE is configured with connected mode DRX configuration (as described earlier) using RRC signaling. For network energy savings, cell DTX and/or Cell DRX can be configured wherein periodic cell DTX/DRX pattern is configured by UE-specific RRC signaling message. Cell DTX and Cell DRX modes can be configured and operated separately (e.g., one RRC configuration set for DL and the other set for UL). The UE specific DRX can be configured in a cell supporting cell DTX and/or Cell DRX.

Periodic cell DTX pattern may be configured by a “duration” and “period” field wherein during the “duration” interval which occurs periodically every “period,” cell does not perform transmission (or stops certain transmissions (e.g., PDSCH, PBCH, SSBs, etc.). Alternately, periodic cell DTX pattern may be configured by a “duration” and “period” field wherein during the “duration” interval which occurs periodically every “period,” cell perform transmission and during the interval “period-duration” cell does not perform transmission (or stops certain transmissions (e.g., PDSCH, PBCH, SSBs, etc.)).

Periodic cell DRX pattern may be configured by a “duration” and “period” field wherein during the “duration” interval which occurs periodically every “period,” cell does not perform reception (or stops certain receptions e.g., PUCCH, PUSCH, PRACH etc.). Alternately, periodic cell DRX pattern may be configured by a “duration” and “period” field wherein during the “duration” interval which occurs periodically every “period,” cell perform reception and during the interval “period-duration” cell does not perform reception (or stops certain receptions e.g., PUCCH, PUSCH, PRACH etc.). During the cell level DRX duration where a network (i.e., base station) does not receive transmission (or certain transmissions) from a UE on the uplink of that cell, the UE does not transmit (or does not transmit) certain transmissions in uplink of that cell.

A UE (or MAC entity in the UE) receives PDCCH indicating a DL/PDSCH transmission (i.e., resources for DL/PDSCH transmission) or the UE receives a MAC PDU in a configured downlink assignment (indicated by configured grant type 1 or configured grant type 2 configuration indicating periodic resources for DL/PDSCH transmission) for unicast:
If HARQ feedback occasion for transmitting the DL HARQ feedback for the DL/PDSCH transmission (indicated by PDCCH or configured downlink assignment) overlaps (partially or fully) with network DRX duration (i.e., cell level DRX duration of cell on which HARQ feedback is to be transmitted; this can be same as or can be different from the cell in which DL/PDSCH transmission indicated by PDCCH or configured downlink assignment is received; HARQ feedback is transmitted on SpCell or PUCCH Scell, DL transmission can be on SpCell or PUCCH Scell or any other Scell):
   A UE or (MAC entity in the UE) does not transmit DL HARQ feedback in HARQ feedback occasion;
   If a network configures (e.g., the network can send an indication in RRC signaling or PDCCH/DCI or system information, the indication can be per cell or per cell group or per BWP and a UE applies the indication accordingly) that the UE starts drx-HARQ-RTT-TimerDL in first symbol after the end of HARQ feedback occasion when HARQ feedback is not transmitted in HARQ feedback occasion (of that cell) in case of overlapping (or if the network indicates/configures enhanced DRX operation for NES):
      A UE or (MAC entity in the UE) starts the drx-HARQ-RTT-TimerDL for the corresponding HARQ process in the first symbol after the end of the HARQ feedback occasion;
      if a drx-HARQ-RTT-TimerDL expires:
         if the data of the corresponding HARQ process was not successfully decoded:
         *start the drx-RetransmissionTimerDL for the corresponding HARQ process in the first symbol after the expiry of drx-HARQ-RTT-TimerDL.
Else:
   A UE or (MAC entity in the UE) transmits DL HARQ feedback in HARQ feedback occasion;
   A UE or (MAC entity in the UE) starts the drx-HARQ-RTT-TimerDL for the corresponding HARQ process in the first symbol after the end of the corresponding transmission carrying the DL HARQ feedback;
   Stop the drx-RetransmissionTimerDL for the corresponding HARQ process.
   if a drx-HARQ-RTT-TimerDL expires:
      if the data of the corresponding HARQ process was not successfully decoded:
         start the drx-RetransmissionTimerDL for the corresponding HARQ process in the first symbol after the expiry of drx-HARQ-RTT-TimerDL.
Cell on which HARQ feedback is to be transmitted by a UE can be same as or can be different from the cell in which DL/PDSCH transmission indicated by PDCCH or configured downlink assignment is received; HARQ feedback is transmitted on SpCell or PUCCH SCell, DL transmission can be on SpCell or PUCCH SCell or any other SCell. PDCCH indicating DL transmission can be received from a cell same or different from the cell on which indicated DL/PDSCH transmission is received by the UE.

Base station configures cell specific DRX for one or more serving cells. During the cell level DRX duration of a cell, a network (i.e., base station) does not receive transmission (or certain transmissions) from a UE on the uplink of that cell.

Base station transmits PDCCH indicating resources for DL transmission. Base station transmits DL TB in indicated resources (these resources are PDSCH resources of a cell). Resources for DL transmission can also be a configured downlink assignment (configured grant type 1 or configured grant type 2 indicating periodic resources for DL/PDSCH transmission) for unicast.
Upon transmitting the DL TB, HARQ feedback is expected from a UE in HARQ feedback occasion corresponding to the DL TB.
If HARQ feedback occasion for receiving the DL HARQ feedback for the DL transmission (indicated by PDCCH or configured downlink assignment) overlaps (partially or fully) with network DRX duration (i.e., cell level DRX duration of cell on which HARQ feedback is to be received):
   Skip the reception of DL HARQ feedback in the HARQ feedback occasion;
   If a network configures (e.g., the network can send an indication in RRC signaling or PDCCH/DCI or system information, the indication can be per cell or per cell group or per BWP and a UE applies the indication accordingly) that the UE starts drx-HARQ-RTT-TimerDL in first symbol after the end of HARQ feedback occasion when HARQ feedback is not transmitted in HARQ feedback occasion (of that cell) in case of overlapping (or if a network indicates/configures enhanced DRX operation for NES):
      starts the drx-HARQ-RTT-TimerDL for the corresponding HARQ process in the first symbol after the end of the HARQ feedback occasion;
      if a drx-HARQ-RTT-TimerDL expires:
      start the drx-Retransmission TimerDL for the corresponding HARQ process in the first symbol after the expiry of drx-HARQ-RTT-TimerDL.
Else:
   Receive DL HARQ feedback in the HARQ feedback occasion;
   A UE or (MAC entity in the UE) starts the drx-HARQ-RTT-TimerDL for the corresponding HARQ process in the first symbol after the end of the HARQ feedback occasion carrying the DL HARQ feedback;
   Stop the drx-RetransmissionTimerDL for the corresponding HARQ process. if a drx-HARQ-RTT-TimerDL expires:
      if the data of the corresponding HARQ process was not successfully decoded (i.e., HARQ NACK is received):
      start the drx-RetransmissionTimerDL for the corresponding HARQ process in the first symbol after the expiry of drx-HARQ-RTT-TimerDL.
Cell on which HARQ feedback is to be received from a UE can be same as or can be different from the cell in which DL/PDSCH transmission indicated by PDCCH or configured downlink assignment is transmitted; HARQ feedback is received on SpCell or PUCCH SCell, DL transmission can be on SpCell or PUCCH SCell or any other SCell. PDCCH indicating DL transmission can be transmitted from a cell same or different from the cell on which indicated DL/PDSCH transmission is transmitted to the UE.

In an embodiment, network DRX duration in above description can be the cell level inactive duration where cell does not receive any transmission from a UE or does not receive any dedicated transmission from the UE or does not receive certain transmissions (e.g., PUCCH/PUSCH) from the UE.

### [Method 3A-1: Sidelink Aspects]

A UE (or MAC entity in the UE) receives PDCCH indicating a SL transmission (i.e., resources for SL transmission) or a MAC PDU is transmitted in a configured sidelink grant:
If PUCCH resources is configured:
   If HARQ feedback occasion for transmitting the SL HARQ feedback over PUCCH overlaps (partially or fully) with network DRX duration (i.e., cell level DRX duration of cell on which HARQ feedback is to be transmitted):
      A UE or (MAC entity in the UE) does not transmit SL HARQ feedback in HARQ feedback occasion;
      If a network configures (e.g., the network can send an indication in RRC signaling or PDCCH/DCI or system information, the indication can be per cell or per cell group or per BWP and a UE applies the indication accordingly) that the UE starts drx-HARQ-RTT-TimerSL in first symbol after the end of HARQ feedback occasion when HARQ feedback is not transmitted in HARQ feedback occasion in case of overlapping (or if the network indicates/configures enhanced DRX operation for NES):
         A UE or (MAC entity in the UE) starts the drx-HARQ-RTT-TimerSL for the corresponding HARQ process in the first symbol after the end of the HARQ feedback occasion for SL HARQ feedback over PUCCH; the UE or (MAC entity in the UE) stops the drx-RetransmissionTimerSL for the corresponding HARQ process.
   Else (non overlapping case):
      A UE or (MAC entity in the UE) transmits SL HARQ feedback in HARQ feedback occasion. The UE or (MAC entity in the UE) starts the drx-HARQ-RTT-TimerSL for the corresponding HARQ process in the first symbol after the end of the corresponding PUCCH transmission carrying the SL HARQ feedback; the UE or (MAC entity in the UE) stops the drx-Retransmission TimerSL for the corresponding HARQ process.
Else (PUCCH resources is not configured):
   start the drx-HARQ-RTT-TimerSL for the corresponding HARQ process at the first symbol after the end of the corresponding PSSCH transmission;
   stop the drx-Retransmission TimerSL for the corresponding HARQ process.
if a drx-HARQ-RTT-TimerSL expires:
   if a HARQ NACK feedback for the corresponding HARQ process is transmitted on PUCCH; or
   if a HARQ NACK feedback for the corresponding HARQ process is not transmitted on PUCCH; or
   if the PUCCH resource is not configured for the SL grant:
start the drx-Retransmission TimerSL for the corresponding HARQ process in the first symbol after the expiry of drx-HARQ-RTT-TimerSL.

### [Method 4]

The UE is in a RRC_CONNECTED state. The UE is configured with connected mode DRX configuration (as described earlier) using RRC signaling. For network energy savings, cell DTX and/or cell DRX can be configured wherein periodic cell DTX/DRX pattern is configured by UE-specific RRC signaling message. Cell DTX and Cell DRX modes can be configured and operated separately (e.g., one RRC configuration set for DL and the other set for UL). The UE specific DRX can be configured in a cell supporting cell DTX and/or cell DRX.

Periodic cell DTX pattern may be configured by a “duration” and “period” field wherein during the “duration” interval which occurs periodically every “period,” cell does not perform transmission (or stops certain transmissions (e.g., PDSCH, PBCH, SSBs, etc.). Alternately, periodic cell DTX pattern may be configured by a “duration” and “period” field wherein during the “duration” interval which occurs periodically every “period,” cell perform transmission and during the interval “period-duration” cell does not perform transmission (or stops certain transmissions (e.g., PDSCH, PBCH, SSBs, etc.)).

Periodic cell DRX pattern may be configured by a “duration” and “period” field wherein during the “duration” interval which occurs periodically every “period,” cell does not perform reception (or stops certain receptions e.g., PUCCH, PUSCH, PRACH etc.). Alternately, periodic cell DRX pattern may be configured by a “duration” and “period” field wherein during the “duration” interval which occurs periodically every “period,” cell perform reception and during the interval “period-duration” cell does not perform reception (or stops certain receptions e.g., PUCCH, PUSCH, PRACH etc.). During the cell level DRX duration where a network (i.e., base station) does not receive transmission (or certain transmissions) from the UE on the uplink of that cell, the UE does not transmit (or does not transmit) certain transmissions in uplink of that cell.

A UE (or MAC entity in the UE) receives PDCCH indicating a DL/PDSCH transmission (i.e., resources for DL/PDSCH transmission) or the UE receives a MAC PDU in a configured downlink assignment (indicated by configured grant type 1 or configured grant type 2 configuration indicating periodic resources for DL/PDSCH transmission) for unicast (as shown in FIG. 4):
If HARQ feedback occasion for transmitting the DL HARQ feedback for the DL/PDSCH transmission (indicated by PDCCH or configured downlink assignment) overlaps (partially or fully) with network DRX duration (i.e., cell level DRX duration of cell on which HARQ feedback is to be transmitted; this can be same as or can be different from the cell in which DL/PDSCH transmission indicated by PDCCH or configured downlink assignment is received; HARQ feedback is transmitted on SpCell or PUCCH SCell, DL transmission can be on SpCell or PUCCH SCell or any other SCell):
   A UE or (MAC entity in the UE) does not transmit DL HARQ feedback in HARQ feedback occasion.
Else (non overlapping case):
   A UE or (MAC entity in the UE) transmits DL HARQ feedback in HARQ feedback occasion. UE or (MAC entity in the UE) starts the drx-HARQ-RTT-TimerDL for the corresponding HARQ process in the first symbol after the end of the corresponding transmission carrying the DL HARQ feedback; the UE or (MAC entity in the UE) stops the drx-Retransmission TimerDL for the corresponding HARQ process.
   if a drx-HARQ-RTT-TimerDL expires:
      if the data of the corresponding HARQ process was not successfully decoded:
         a UE or (MAC entity in the UE) starts the drx-Retransmission TimerDL for the corresponding HARQ process in the first symbol after the expiry of drx-HARQ-RTT-TimerDL.
Cell on which HARQ feedback is to be transmitted by UE or (MAC entity in the UE) can be same as or can be different from the cell in which DL/PDSCH transmission indicated by PDCCH or configured downlink assignment is received; HARQ feedback is transmitted on SpCell or PUCCH SCell, DL transmission can be on SpCell or PUCCH SCell or any other SCell. PDCCH indicating DL transmission can be received from a cell, same or different from the cell on which indicated DL/PDSCH transmission is received by the UE or (MAC entity in the UE).

Base station configures cell specific DRX for one or more serving cells. During the cell level DRX duration of a cell, a network (i.e., base station) does not receive transmission (or certain transmissions) from the UE on the uplink of that cell.

Base station transmits PDCCH indicating resources for DL transmission. Base station transmits DL TB in indicated resources (these resources are PDSCH resources of a cell). Resources for DL transmission can also be a configured downlink assignment (indicated by configured grant type 1 or configured grant type 2 configuration indicating periodic resources for DL/PDSCH transmission) for unicast.
Upon transmitting the DL TB, HARQ feedback is expected from the UE in HARQ feedback occasion corresponding to the DL TB.
If HARQ feedback occasion for receiving the DL HARQ feedback for the DL transmission (indicated by PDCCH or configured downlink assignment) overlaps (partially or fully) with network DRX duration (i.e., cell level DRX duration of cell on which HARQ feedback is to be received):
   base station does not receive DL HARQ feedback in the HARQ feedback occasion
else:
   base station receive DL HARQ feedback in the HARQ feedback occasion;
   Starts the drx-HARQ-RTT-TimerDL for the corresponding HARQ process in the first symbol after the end of the corresponding transmission carrying the DL HARQ feedback;
   Stop the drx-Retransmission TimerDL for the corresponding HARQ process.
   if a drx-HARQ-RTT-TimerDL expires:
      if the data of the corresponding HARQ process was not successfully decoded (i.e., HARQ NACK is received):

Start the drx-Retransmission TimerDL for the corresponding HARQ process in the first symbol after the expiry of drx-HARQ-RTT-TimerDL.

Cell on which HARQ feedback is to be received from a UE can be same as or can be different from the cell in which DL/PDSCH transmission indicated by PDCCH or configured downlink assignment is transmitted; HARQ feedback is received on SpCell or PUCCH SCell, DL transmission can be on SpCell or PUCCH SCell or any other SCell. PDCCH indicating DL transmission can be transmitted from a cell same or different from the cell on which indicated DL/PDSCH transmission is transmitted to the UE.

In an embodiment, network DRX duration in above description can be the cell level inactive duration where cell does not receive any transmission from a UE or does not receive any dedicated transmission from the UE or does not receive certain transmissions (e.g., PUCCH/PUSCH) from the UE.

### [Method 4-1: Sidelink Aspects]

A UE (or MAC entity in the UE) receives PDCCH indicating a SL transmission (i.e., resources for SL transmission) or a MAC PDU is transmitted in a configured sidelink grant:
If PUCCH resources is configured:
   If HARQ feedback occasion for transmitting the SL HARQ feedback over PUCCH overlaps (partially or fully) with network DRX duration (i.e., cell level DRX duration of cell on which HARQ feedback is to be transmitted):
      UE or (MAC entity in the UE) does not transmits SL HARQ feedback in HARQ feedback occasion to gNB.
   Else (non overlapping case):
      A UE or (MAC entity in the UE) transmits SL HARQ feedback in HARQ feedback occasion. The UE or (MAC entity in the UE) starts the drx-HARQ-RTT-TimerSL for the corresponding HARQ process in the first symbol after the end of the corresponding PUCCH transmission carrying the SL HARQ feedback; the UE or (MAC entity in the UE) stops the drx-Retransmission TimerSL for the corresponding HARQ process.
Else (PUCCH resources is not configured):
   start the drx-HARQ-RTT-TimerSL for the corresponding HARQ process at the first symbol after the end of the corresponding PSSCH transmission;
   stop the drx-RetransmissionTimerSL for the corresponding HARQ process.
if a drx-HARQ-RTT-TimerSL expires:
   if a HARQ NACK feedback for the corresponding HARQ process is transmitted on PUCCH; or
   if a HARQ NACK feedback for the corresponding HARQ process is not transmitted on PUCCH; or
   if the PUCCH resource is not configured for the SL grant:
      start the drx-RetransmissionTimerSL for the corresponding HARQ process in the first symbol after the expiry of drx-HARQ-RTT-TimerSL.

### [Method 5]

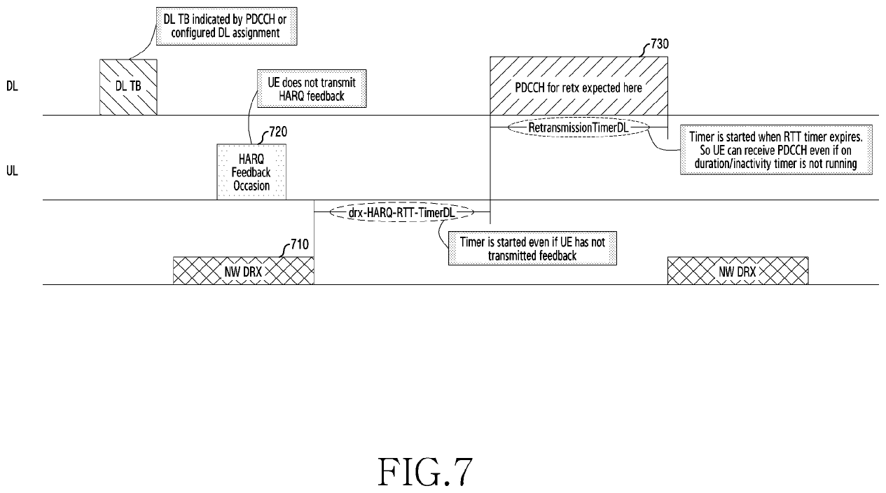

FIG. 7 illustrates another example of PDCCH reception with respect to overlap of network DRX duration and HARQ feedback occasion in accordance with an embodiment of the disclosure.

A UE is in a RRC_CONNECTED state. The UE is configured with connected mode DRX configuration (as described earlier) using RRC signaling. For network energy savings, cell DTX and/or Cell DRX can be configured wherein periodic cell DTX/DRX pattern is configured by UE-specific RRC signaling message. Cell DTX and cell DRX modes can be configured and operated separately (e.g., one RRC configuration set for DL and the other set for UL). The UE specific DRX can be configured in a cell supporting cell DTX and/or cell DRX.

Periodic cell DTX pattern may be configured by a “duration” and “period” field wherein during the “duration” interval which occurs periodically every “period,” cell does not perform transmission (or stops certain transmissions (e.g., PDSCH, PBCH, SSBs, etc.). Alternately, periodic cell DTX pattern may be configured by a “duration” and “period” field wherein during the “duration” interval which occurs periodically every “period,” cell perform transmission and during the interval “period-duration” cell does not perform transmission (or stops certain transmissions (e.g., PDSCH, PBCH, SSBs, etc.)).

Periodic cell DRX pattern may be configured by a “duration” and “period” field wherein during the “duration” interval which occurs periodically every “period,” cell does not perform reception (or stops certain receptions e.g., PUCCH, PUSCH, PRACH etc.). Alternately, periodic cell DRX pattern may be configured by a “duration” and “period” field wherein during the “duration” interval which occurs periodically every “period,” cell perform reception and during the interval “period-duration” cell does not perform reception (or stops certain receptions e.g., PUCCH, PUSCH, PRACH etc.). During the cell level DRX duration where a network (i.e., base station) does not receive transmission (or certain transmissions) from the UE on the uplink of that cell, the UE does not transmit (or does not transmit) certain transmissions in uplink of that cell.

A UE (or MAC entity in the UE) receives PDCCH indicating a DL/PDSCH transmission (i.e., resources for DL/PDSCH transmission) or the UE receives a MAC PDU in a configured downlink assignment (indicated by configured grant type 1 or configured grant type 2 configuration indicating periodic resources for DL/PDSCH transmission) for unicast (as shown in FIG. 7):
If HARQ feedback occasion for transmitting the DL HARQ feedback for the DL/PDSCH transmission (indicated by PDCCH or configured downlink assignment) overlaps (partially or fully) with network DRX duration (i.e., cell level DRX duration of cell on which HARQ feedback is to be transmitted (710); this can be same as or can be different from the cell in which DL/PDSCH transmission indicated by PDCCH or configured downlink assignment is received; HARQ feedback is transmitted on SpCell or PUCCH SCell, DL transmission can be on SpCell or PUCCH SCell or any other SCell):
   A UE or (MAC entity in the UE) does not transmit DL HARQ feedback in HARQ feedback occasion (720);
   A UE or (MAC entity in the UE) starts the drx-HARQ-RTT-TimerDL for the corresponding HARQ process in the first symbol after the end of the network DRX duration (or in first symbol at an offset after the end of the network DRX duration);
   if a drx-HARQ-RTT-TimerDL expires:
      if the data of the corresponding HARQ process was not successfully decoded:
   start the drx-RetransmissionTimerDL for the corresponding HARQ process in the first symbol after the expiry of drx-HARQ-RTT-TimerDL (730).
Else:
   A UE or (MAC entity in the UE) transmits DL HARQ feedback in HARQ feedback occasion;
   A UE or (MAC entity in the UE) starts the drx-HARQ-RTT-TimerDL for the corresponding HARQ process in the first symbol after the end of the corresponding transmission carrying the DL HARQ feedback;
   Stop the drx-Retransmission TimerDL for the corresponding HARQ process.
   if a drx-HARQ-RTT-TimerDL expires:
      if the data of the corresponding HARQ process was not successfully decoded:
         start the drx-RetransmissionTimerDL for the corresponding HARQ process in the first symbol after the expiry of drx-HARQ-RTT-TimerDL.
Cell on which HARQ feedback is to be transmitted by a UE can be same as or can be different from the cell in which DL/PDSCH transmission indicated by PDCCH or configured downlink assignment is received; HARQ feedback is transmitted on SpCell or PUCCH SCell, DL transmission can be on SpCell or PUCCH SCell or any other SCell. PDCCH indicating DL transmission can be received from a cell same or different from the cell on which indicated DL/PDSCH transmission is received by the UE.

Base station configures cell specific DRX for one or more serving cells. During the cell level DRX duration of a cell, a network (i.e., base station) does not receive transmission (or certain transmissions) from a UE on the uplink of that cell.

Base station transmits PDCCH indicating resources for DL transmission. Base station transmits DL TB in indicated resources (these resources are PDSCH resources of a cell). Resources for DL transmission can also be a configured downlink assignment (indicated by configured grant type 1 or configured grant type 2 configuration indicating periodic resources for DL/PDSCH transmission) for unicast.
Upon transmitting the DL TB, HARQ feedback is expected from a UE in HARQ feedback occasion corresponding to the DL TB.
If HARQ feedback occasion for receiving the DL HARQ feedback for the DL transmission (indicated by PDCCH or configured downlink assignment) overlaps (partially or fully) with network DRX duration (i.e., cell level DRX duration of cell on which HARQ feedback is to be received):
   Skip the reception of DL HARQ feedback in the HARQ feedback occasion;
   starts the drx-HARQ-RTT-TimerDL for the corresponding HARQ process in the first symbol after the end of the network DRX duration (or in first symbol at an offset after the end of the network DRX duration);
   if a drx-HARQ-RTT-TimerDL expires:
      start the drx-Retransmission TimerDL for the corresponding HARQ process in the first symbol after the expiry of drx-HARQ-RTT-TimerDL.
Else:
   Receive DL HARQ feedback in the HARQ feedback occasion;
   starts the drx-HARQ-RTT-TimerDL for the corresponding HARQ process in the first symbol after the end of HARQ feedback occasion carrying the DL HARQ feedback;
   Stop the drx-Retransmission TimerDL for the corresponding HARQ process.
   if a drx-HARQ-RTT-TimerDL expires:
      start the drx-Retransmission TimerDL for the corresponding HARQ process in the first symbol after the expiry of drx-HARQ-RTT-TimerDL.
Cell on which HARQ feedback is to be received from a UE can be same as or can be different from the cell in which DL/PDSCH transmission indicated by PDCCH or configured downlink assignment is transmitted; HARQ feedback is received on SpCell or PUCCH SCell, DL transmission can be on SpCell or PUCCH SCell or any other SCell. PDCCH indicating DL transmission can be transmitted from a cell same or different from the cell on which indicated DL/PDSCH transmission is transmitted to the UE.

In an embodiment, network DRX duration in above description can be the cell level inactive duration where cell does not receive any transmission from a UE or does not receive any dedicated transmission from the UE or does not receive certain transmissions (e.g., PUCCH/PUSCH) from the UE.

### [Method 5-1: Sidelink Aspects]

A UE (or MAC entity in the UE) receives PDCCH indicating a SL transmission (i.e., resources for SL transmission) or a MAC PDU is transmitted in a configured sidelink grant:
If PUCCH resources is configured:
   If HARQ feedback occasion for transmitting the SL HARQ feedback over PUCCH overlaps (partially or fully) with network DRX duration (i.e., cell level DRX duration of cell on which HARQ feedback is to be transmitted):
      A UE or (MAC entity in the UE) does not transmit SL HARQ feedback in HARQ feedback occasion to gNB
      A UE or (MAC entity in the UE) starts the drx-HARQ-RTT-TimerSL for the corresponding HARQ process in the first symbol after the end of the network DRX duration (or in first symbol at an offset after the end of the network DRX duration);
      A UE or (MAC entity in the UE stops the drx-Retransmission TimerSL for the corresponding HARQ process.
   Else (non overlapping case):
      A UE or (MAC entity in the UE) transmits SL HARQ feedback in HARQ feedback occasion. The UE or (MAC entity in the UE) starts the drx-HARQ-RTT-TimerSL for the corresponding HARQ process in the first symbol after the end of the corresponding PUCCH transmission carrying the SL HARQ feedback; the UE or (MAC entity in the UE) stops the drx-RetransmissionTimerSL for the corresponding HARQ process.
Else (PUCCH resources is not configured):
   start the drx-HARQ-RTT-TimerSL for the corresponding HARQ process at the first symbol after the end of the corresponding PSSCH transmission;
   stop the drx-RetransmissionTimerSL for the corresponding HARQ process.
if a drx-HARQ-RTT-TimerSL expires:
   if a HARQ NACK feedback for the corresponding HARQ process is transmitted on PUCCH; or
   if a HARQ NACK feedback for the corresponding HARQ process is not transmitted on PUCCH; or
   if the PUCCH resource is not configured for the SL grant:
start the drx-Retransmission TimerSL for the corresponding HARQ process in the first symbol after the expiry of drx-HARQ-RTT-TimerSL.

### [Method 6]

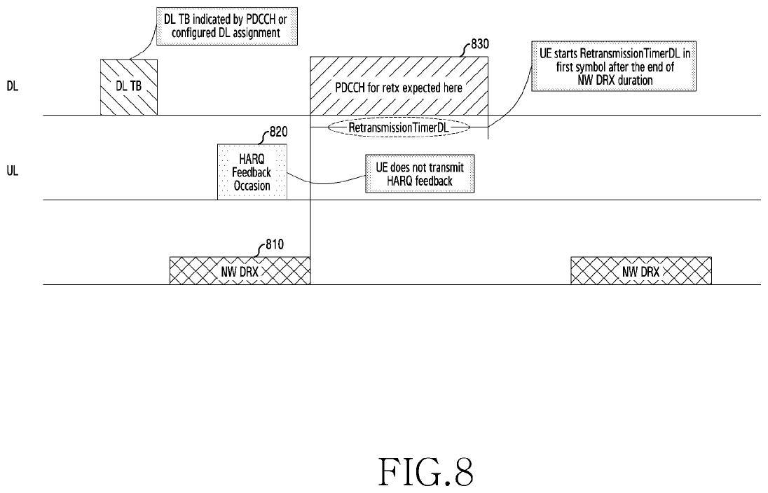

FIG. 8 illustrates another example of PDCCH reception with respect to overlap of network DRX duration and HARQ feedback occasion in accordance with an embodiment of the present disclosure.

A UE is in a RRC_CONNECTED state. The UE is configured with connected mode DRX configuration (as described earlier) using RRC signaling. For network energy savings, cell DTX and/or Cell DRX can be configured wherein periodic cell DTX/DRX pattern is configured by UE-specific RRC signaling message. Cell DTX and cell DRX modes can be configured and operated separately (e.g., one RRC configuration set for DL and the other set for UL). The UE specific DRX can be configured in a cell supporting cell DTX and/or cell DRX.

Periodic cell DTX pattern may be configured by a “duration” and “period” field wherein during the “duration” interval which occurs periodically every “period,” cell does not perform transmission (or stops certain transmissions (e.g., PDSCH, PBCH, SSBs, etc.). Alternately, periodic cell DTX pattern may be configured by a “duration” and “period” field wherein during the “duration” interval which occurs periodically every “period,” cell perform transmission and during the interval “period-duration” cell does not perform transmission (or stops certain transmissions (e.g., PDSCH, PBCH, SSBs, etc.)).

Periodic cell DRX pattern may be configured by a “duration” and “period” field wherein during the “duration” interval which occurs periodically every “period,” cell does not perform reception (or stops certain receptions e.g., PUCCH, PUSCH, PRACH etc.). Alternately, periodic cell DRX pattern may be configured by a “duration” and “period” field wherein during the “duration” interval which occurs periodically every “period,” cell perform reception and during the interval “period-duration” cell does not perform reception (or stops certain receptions e.g., PUCCH, PUSCH, PRACH etc.). During the cell level DRX duration where a network (i.e., base station) does not receive transmission (or certain transmissions) from a UE on the uplink of that cell, the UE does not transmit (or does not transmit) certain transmissions in uplink of that cell.

A UE (or MAC entity in the UE) receives PDCCH indicating a DL/PDSCH transmission (i.e., resources for DL/PDSCH transmission) or the UE receives a MAC PDU in a configured downlink assignment (indicated by configured grant type 1 or configured grant type 2 configuration indicating periodic resources for DL/PDSCH transmission) for unicast (as shown in FIG. 8):
If HARQ feedback occasion for transmitting the DL HARQ feedback for the DL/PDSCH transmission (indicated by PDCCH or configured downlink assignment) overlaps (partially or fully) with network DRX duration (i.e., cell level DRX duration of cell on which HARQ feedback is to be transmitted (810); this can be same as or can be different from the cell in which DL/PDSCH transmission indicated by PDCCH or configured downlink assignment is received; HARQ feedback is transmitted on SpCell or PUCCH SCell, DL transmission can be on SpCell or PUCCH SCell or any other SCell):
   A UE or (MAC entity in the UE) does not transmit DL HARQ feedback in HARQ feedback occasion (820);
   A UE or (MAC entity in the UE) starts the drx-Retransmission TimerDL for the corresponding HARQ process in the first symbol after the end of the NW DRX duration (or in the first symbol at an offset after the end of the NW DRX duration, where offset is pre-defined or signalled by base station in RRC signaling or system info) (830);
Else:
   A UE or (MAC entity in the UE) transmits DL HARQ feedback in HARQ feedback occasion;
   A UE or (MAC entity in the UE) starts the drx-HARQ-RTT-TimerDL for the corresponding HARQ process in the first symbol after the end of the corresponding transmission carrying the DL HARQ feedback;
   Stop the drx-Retransmission TimerDL for the corresponding HARQ process.
   if a drx-HARQ-RTT-TimerDL expires:
      if the data of the corresponding HARQ process was not successfully decoded:
      start the drx-RetransmissionTimerDL for the corresponding HARQ process in the first symbol after the expiry of drx-HARQ-RTT-TimerDL.
Cell on which HARQ feedback is to be transmitted by a UE can be same as or can be different from the cell in which DL/PDSCH transmission indicated by PDCCH or configured downlink assignment is received; HARQ feedback is transmitted on SpCell or PUCCH SCell, DL transmission can be on SpCell or PUCCH SCell or any other SCell. PDCCH indicating DL transmission can be received from a cell same or different from the cell on which indicated DL/PDSCH transmission is received by the UE.

Base station configures cell specific DRX for one or more serving cells. During the cell level DRX duration of a cell, a network (i.e., base station) does not receive transmission (or certain transmissions) from a UE on the uplink of that cell.

Base station transmits PDCCH indicating resources for DL transmission. Base station transmits DL TB in indicated resources (these resources are PDSCH resources of a cell). Resources for DL transmission can also be a configured downlink assignment (indicated by configured grant type 1 or configured grant type 2 configuration indicating periodic resources for DL/PDSCH transmission) for unicast.
Upon transmitting the DL TB, HARQ feedback is expected from a UE in HARQ feedback occasion corresponding to the DL TB.
If HARQ feedback occasion for receiving the DL HARQ feedback for the DL transmission (indicated by PDCCH or configured downlink assignment) overlaps (partially or fully) with network DRX duration (i.e., cell level DRX duration of cell on which HARQ feedback is to be received):
   Skip the reception of DL HARQ feedback in the HARQ feedback occasion;
   starts the drx-RetransmissionTimerDL for the corresponding HARQ process in the first symbol after the end of the NW DRX duration (or in the first symbol at an offset after the end of the NW DRX duration, where offset is signalled by base station in RRC signaling or system info).
Else:
   Receive DL HARQ feedback in the HARQ feedback occasion;
   starts the drx-HARQ-RTT-TimerDL for the corresponding HARQ process in the first symbol after the end of the HARQ feedback occasion carrying the DL HARQ feedback;
   Stop the drx-RetransmissionTimerDL for the corresponding HARQ process.
   if a drx-HARQ-RTT-TimerDL expires:
      if the data of the corresponding HARQ process was not successfully decoded (i.e., HARQ NACK is received):
         Start the drx-RetransmissionTimerDL for the corresponding HARQ process in the first symbol after the expiry of drx-HARQ-RTT-TimerDL.
Cell on which HARQ feedback is to be received from a UE can be same as or can be different from the cell in which DL/PDSCH transmission indicated by PDCCH or configured downlink assignment is transmitted; HARQ feedback is received on SpCell or PUCCH SCell, DL transmission can be on SpCell or PUCCH SCell or any other SCell. PDCCH indicating DL transmission can be transmitted from a cell same or different from the cell on which indicated DL/PDSCH transmission is transmitted to the UE.

In an embodiment, network DRX duration in above description can be the cell level inactive duration where cell does not receive any transmission from a UE or does not receive any dedicated transmission from the UE or does not receive certain transmissions (e.g., PUCCH/PUSCH) from the UE.

### [Method 6-1: Sidelink Aspects]

A UE (or MAC entity in the UE) receives PDCCH indicating a SL transmission (i.e., resources for SL transmission) or a MAC PDU is transmitted in a configured sidelink grant:
If PUCCH resources is configured:
   If HARQ feedback occasion for transmitting the SL HARQ feedback over PUCCH overlaps (partially or fully) with network DRX duration (i.e., cell level DRX duration of cell on which HARQ feedback is to be transmitted):
      A UE or (MAC entity in the UE) does not transmit SL HARQ feedback in HARQ feedback occasion to gNB;
      A UE or (MAC entity in the UE) starts the drx-Retransmission TimerSL for the corresponding HARQ process in the first symbol after the end of the NW DRX duration (or in the first symbol at an offset after the end of the NW DRX duration, where offset is pre-defined or signalled by base station in RRC signaling or system info);
   Else (non overlapping case):
      A UE or (MAC entity in the UE) transmits SL HARQ feedback in HARQ feedback occasion. The UE or (MAC entity in the UE) starts the drx-HARQ-RTT-TimerSL for the corresponding HARQ process in the first symbol after the end of the corresponding PUCCH transmission carrying the SL HARQ feedback; the UE or (MAC entity in the UE) stops the drx-Retransmission TimerSL for the corresponding HARQ process.
Else (PUCCH resources is not configured):
   start the drx-HARQ-RTT-TimerSL for the corresponding HARQ process at the first symbol after the end of the corresponding PSSCH transmission;
   stop the drx-RetransmissionTimerSL for the corresponding HARQ process.
if a drx-HARQ-RTT-TimerSL expires:
   if a HARQ NACK feedback for the corresponding HARQ process is transmitted on PUCCH; or
   if a HARQ NACK feedback for the corresponding HARQ process is not transmitted on PUCCH; or
   if the PUCCH resource is not configured for the SL grant:
      start the drx-RetransmissionTimerSL for the corresponding HARQ process in the first symbol after the expiry of drx-HARQ-RTT-TimerSL.

### [Method 7]

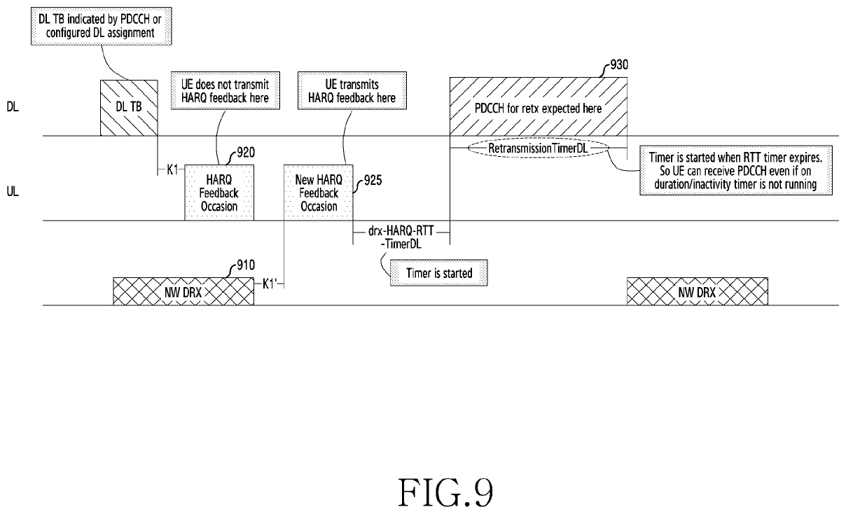

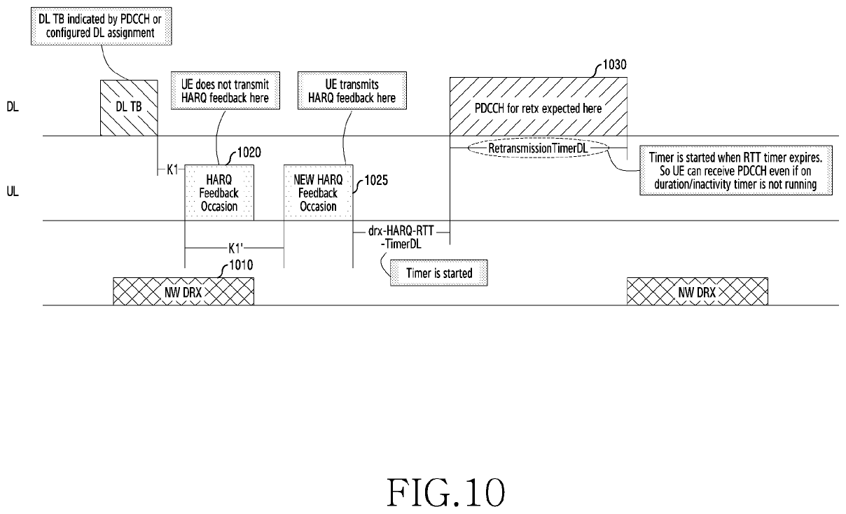

FIG. 9 and FIG. 10 illustrate other examples of PDCCH reception with respect to overlap of network DRX duration and HARQ feedback occasion in accordance with an embodiment of the present disclosure.

A UE is in a RRC_CONNECTED state. The UE is configured with connected mode DRX configuration (as described earlier) using RRC signaling. For network energy savings, cell DTX and/or Cell DRX can be configured wherein periodic cell DTX/DRX pattern is configured by UE-specific RRC signaling message. Cell DTX and cell DRX modes can be configured and operated separately (e.g., one RRC configuration set for DL and the other set for UL). The UE specific DRX can be configured in a cell supporting cell DTX and/or cell DRX.

Periodic cell DTX pattern may be configured by a “duration” and “period” field wherein during the “duration” interval which occurs periodically every “period,” cell does not perform transmission (or stops certain transmissions (e.g., PDSCH, PBCH, SSBs, etc.). Alternately, periodic cell DTX pattern may be configured by a “duration” and “period” field wherein during the “duration” interval which occurs periodically every “period,” cell perform transmission and during the interval “period-duration” cell does not perform transmission (or stops certain transmissions (e.g., PDSCH, PBCH, SSBs, etc.)).

Periodic cell DRX pattern may be configured by a “duration” and “period” field wherein during the “duration” interval which occurs periodically every “period,” cell does not perform reception (or stops certain receptions e.g., PUCCH, PUSCH, PRACH etc.). Alternately, periodic cell DRX pattern may be configured by a “duration” and “period” field wherein during the “duration” interval which occurs periodically every “period,” cell perform reception and during the interval “period-duration” cell does not perform reception (or stops certain receptions e.g., PUCCH, PUSCH, PRACH etc.). During the cell level DRX duration where a network (i.e., base station) does not receive transmission (or certain transmissions) from the UE on the uplink of that cell, the UE does not transmit (or does not transmit) certain transmissions in uplink of that cell.

A UE (or MAC entity in the UE) receives PDCCH indicating a DL/PDSCH transmission (i.e., resources for DL/PDSCH transmission) or the UE receives a MAC PDU in a configured downlink assignment (indicated by configured grant type 1 or configured grant type 2 configuration indicating periodic resources for DL/PDSCH transmission) for unicast (as shown in FIG. 9 and FIG. 10):
A UE or (MAC entity in the UE) determines HARQ feedback occasion wherein the HARQ feedback occasion starts at an offset K1 from the end of DL/PDSCH transmission.
If this HARQ feedback occasion for transmitting the DL HARQ feedback for the DL/PDSCH transmission (indicated by PDCCH or configured downlink assignment) overlaps (partially or fully) with network DRX duration (i.e., cell level DRX duration of cell on which HARQ feedback is to be transmitted (910, 920, 1010, 1020); this can be same as or can be different from the cell in which DL/PDSCH transmission indicated by PDCCH or configured downlink assignment is received; HARQ feedback is transmitted on SpCell or PUCCH SCell, DL transmission can be on SpCell or PUCCH SCell or any other SCell):
   A UE or (MAC entity in the UE) determines another HARQ feedback occasion wherein the HARQ feedback occasion starts at an offset K1′ from the end of the network DRX duration (925). K1′ can be signaled in RRC signaling message or in PDCCH. The time duration (symbols) and frequency resources (PRBs) for HARQ feedback occasion can be same as the HARQ feedback occasion which overlaps with network DRX duration. The value of K1′ used here can be same or different from the K1 (as shown in FIG. 9).
   (Alternate) a UE or (MAC entity in the UE) determines another HARQ feedback occasion wherein the HARQ feedback occasion starts at an offset K1′ from the end of DL/PDSCH transmission (1025). K1′ can be signaled in RRC signaling message or in PDCCH. The time duration (symbols) and frequency resources (PRBs) for HARQ feedback occasion can be same as the HARQ feedback occasion which overlaps with network DRX duration. The value of K1′ used here is different from the K1 (as shown in FIG. 10).
   A UE or (MAC entity in the UE) transmit DL HARQ feedback in the determined HARQ feedback occasion (925, 1025);
   A UE or (MAC entity in the UE) starts the dix-HARQ-RTT-TimerDL for the corresponding HARQ process in the first symbol after the end of the corresponding transmission carrying the DL HARQ feedback;
   Stop the drx-Retransmission TimerDL for the corresponding HARQ process.
   if a drx-HARQ-RTT-TimerDL expires:
      if the data of the corresponding HARQ process was not successfully decoded:
   start the drx-Retransmission TimerDL for the corresponding HARQ process in the first symbol after the expiry of drx-HARQ-RTT-TimerDL (930, 1030).
Else:
   A UE or (MAC entity in the UE) transmits DL HARQ feedback in HARQ feedback occasion
   A UE or (MAC entity in the UE) starts the drx-HARQ-RTT-TimerDL for the corresponding HARQ process in the first symbol after the end of the corresponding transmission carrying the DL HARQ feedback;
   Stop the drx-RetransmissionTimerDL for the corresponding HARQ process.
   if a drx-HARQ-RTT-TimerDL expires:
      if the data of the corresponding HARQ process was not successfully decoded:
         start the drx-RetransmissionTimerDL for the corresponding HARQ process in the first symbol after the expiry of drx-HARQ-RTT-TimerDL.
Cell on which HARQ feedback is to be transmitted by a UE can be same as or can be different from the cell in which DL/PDSCH transmission indicated by PDCCH or configured downlink assignment is received; HARQ feedback is transmitted on SpCell or PUCCH SCell, DL transmission can be on SpCell or PUCCH SCell or any other SCell. PDCCH indicating DL transmission can be received from a cell same or different from the cell on which indicated DL/PDSCH transmission is received by the UE.

Base station configures cell specific DRX for one or more serving cells. During the cell level DRX duration of a cell, a network (i.e., base station) does not receive transmission (or certain transmissions) from a UE on the uplink of that cell.

Base station transmits PDCCH indicating resources for DL transmission. Base station transmits DL TB in indicated resources (these resources are PDSCH resources of a cell). Resources for DL transmission can also be a configured downlink assignment (indicated by configured grant type 1 or configured grant type 2 configuration indicating periodic resources for DL/PDSCH transmission) for unicast.
Upon transmitting the DL TB, HARQ feedback is expected from a UE in HARQ feedback occasion corresponding to the DL TB.
Determine HARQ feedback occasion wherein the HARQ feedback occasion starts at an offset K1 from the end of DL/PDSCH transmission
If HARQ feedback occasion for receiving the DL HARQ feedback for the DL transmission (indicated by PDCCH or configured downlink assignment) overlaps (partially or fully) with network DRX duration (i.e., cell level DRX duration of cell on which HARQ feedback is to be received):
   Determines another HARQ feedback occasion wherein the HARQ feedback occasion starts at an offset K1′ from the end of the network DRX duration. K1′ can be signaled in RRC signaling message or in PDCCH. The time duration (symbols) and frequency resources (PRBs) for HARQ feedback occasion can be same as the HARQ feedback occasion which overlaps with network DRX duration. The value of K1′ used here can be same or different from the K1.
   (Alternate) determines another HARQ feedback occasion wherein the HARQ feedback occasion starts at an offset K1′ from the end of DL/PDSCH transmission. K1′ can be signaled in RRC signaling message or in PDCCH. The time duration (symbols) and frequency resources (PRBs) for HARQ feedback occasion can be same as the HARQ feedback occasion which overlaps with network DRX duration. The value of K1′ used here is different from the K1.
   Receive DL HARQ feedback in the HARQ feedback occasion;
   starts the drx-HARQ-RTT-TimerDL for the corresponding HARQ process in the first symbol after the end of HARQ feedback occasion carrying the DL HARQ feedback;
   Stop the drx-RetransmissionTimerDL for the corresponding HARQ process.
   if a drx-HARQ-RTT-TimerDL expires:
      start the drx-RetransmissionTimerDL for the corresponding HARQ process in the first symbol after the expiry of drx-HARQ-RTT-TimerDL.
Else
   Receive DL HARQ feedback in the HARQ feedback occasion;
   starts the drx-HARQ-RTT-TimerDL for the corresponding HARQ process in the first symbol after the end of HARQ feedback occasion carrying the DL HARQ feedback;
   Stop the drx-RetransmissionTimerDL for the corresponding HARQ process.
   if a drx-HARQ-RTT-TimerDL expires:
      start the drx-RetransmissionTimerDL for the corresponding HARQ process in the first symbol after the expiry of drx-HARQ-RTT-TimerDL.
Cell on which HARQ feedback is to be received from a UE can be same as or can be different from the cell in which DL/PDSCH transmission indicated by PDCCH or configured downlink assignment is transmitted; HARQ feedback is received on SpCell or PUCCH SCell, DL transmission can be on SpCell or PUCCH Scell or any other Scell. PDCCH indicating DL transmission can be transmitted from a cell same or different from the cell on which indicated DL/PDSCH transmission is transmitted to the UE.

In an embodiment, network DRX duration in above description can be the cell level inactive duration where cell does not receive any transmission from a UE or does not receive any dedicated transmission from the UE or does not receive certain transmissions (e.g., PUCCH/PUSCH) from the UE.

### [Method 7-1: Sidelink Aspects]

A UE (or MAC entity in the UE) receives PDCCH indicating a SL transmission (i.e., resources for SL transmission) or a MAC PDU is transmitted in a configured sidelink grant:
If PUCCH resources is configured:
   A UE or (MAC entity in the UE) determines HARQ feedback occasion wherein the HARQ feedback occasion starts at an offset K1 from the end of PSSCH transmission to another UE or PSFCH reception from the UE to which PSSCH is transmitted.
   If HARQ feedback occasion for transmitting the SL HARQ feedback over PUCCH overlaps (partially or fully) with network DRX duration (i.e., cell level DRX duration of cell on which HARQ feedback is to be transmitted):
      Determines another HARQ feedback occasion wherein the HARQ feedback occasion starts at an offset K1′ from the end of the network DRX duration. K1′ can be signaled in RRC signaling message or in PDCCH. The time duration (symbols) and frequency resources (PRBs) for HARQ feedback occasion can be same as the HARQ feedback occasion which overlaps with network DRX duration. The value of K1′ used here can be same or different from the K1.
      (Alternate) determines another HARQ feedback occasion wherein the HARQ feedback occasion starts at an offset K1′ from the end of PSSCH transmission to another UE or PSFCH reception from the UE to which PSSCH is transmitted. K1′ can be signaled in RRC signaling message or in PDCCH. The time duration (symbols) and frequency resources (PRBs) for HARQ feedback occasion can be same as the HARQ feedback occasion which overlaps with network DRX duration. The value of K1′ used here is different from the K1.
      A UE or (MAC entity in the UE) transmits SL HARQ feedback in the new HARQ feedback occasion to a gNB;
      A UE or (MAC entity in the UE) starts the drx-HARQ-RTT-TimerSL for the corresponding HARQ process in the first symbol after the end of the corresponding PUCCH transmission carrying the SL HARQ feedback;
      A UE or (MAC entity in the UE stops the drx-RetransmissionTimerSL for the corresponding HARQ process.
   Else (non overlapping case):
      A UE or (MAC entity in the UE) transmits SL HARQ feedback in HARQ feedback occasion. The UE or (MAC entity in the UE) starts the drx-HARQ-RTT-TimerSL for the corresponding HARQ process in the first symbol after the end of the corresponding PUCCH transmission carrying the SL HARQ feedback; the UE or (MAC entity in the UE) stops the drx-Retransmission TimerSL for the corresponding HARQ process.
Else (PUCCH resources is not configured):
   start the drx-HARQ-RTT-TimerSL for the corresponding HARQ process at the first symbol after the end of the corresponding PSSCH transmission;
   stop the drx-Retransmission TimerSL for the corresponding HARQ process.
if a drx-HARQ-RTT-TimerSL expires:
   if a HARQ NACK feedback for the corresponding HARQ process is transmitted on PUCCH; or
   if a HARQ NACK feedback for the corresponding HARQ process is not transmitted on PUCCH; or
   if the PUCCH resource is not configured for the SL grant:
start the drx-Retransmission TimerSL for the corresponding HARQ process in the first symbol after the expiry of drx-HARQ-RTT-TimerSL.

The embodiments and methods described in method 1 to method 7 can also be applied for multicast and broadcast service (MBS) for the case i.e., if the PDCCH indicates a DL multicast transmission and if HARQ feedback is enabled, by replacing the parameter drx-HARQ-RTT-TimerDL to drx-HARQ-RTT-TimerDL-PTM and replacing the parameter drx-Retransmission TimerDL to drx-Retransmission TimerDL-PTM.

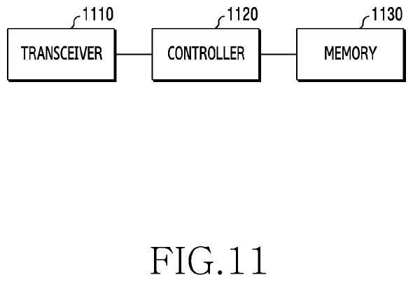

FIG. 11 illustrates a terminal according to an embodiment of the present disclosure.

Referring to FIG. 11, a terminal includes a transceiver 1110, a controller 1120 and a memory 1130. The controller 1120 may refer to a circuitry, an application-specific integrated circuit (ASIC), or at least one processor. The transceiver 1110, the controller 1120 and the memory 1130 are configured to perform the operations of the UE illustrated in the figures, e.g., FIGS. 1 to 10 or described above. Although the transceiver 1110, the controller 1120 and the memory 1130 are shown as separate entities, they may be realized as a single entity like a single chip. Or the transceiver 1110, the controller 1120 and the memory 1130 may be electrically connected to or coupled with each other.

The transceiver 1110 may transmit and receive signals to and from other network entities (e.g., a base station or another terminal).

The controller 1120 may control the UE to perform functions according to one of the embodiments described above.

In an embodiment, the operations of the terminal may be implemented using the memory 1130 storing corresponding program codes. Specifically, the terminal may be equipped with the memory 1130 to store program codes implementing desired operations. To perform the desired operations, the controller 1120 may read and execute the program codes stored in the memory 1130 by using a processor or a central processing unit (CPU).

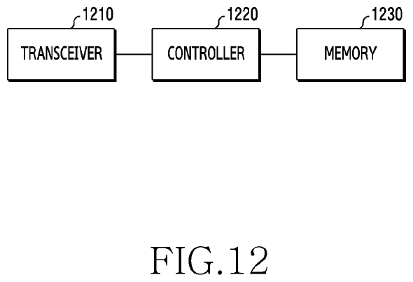

FIG. 12 illustrates a base station according to an embodiment of the present disclosure.

Referring to FIG. 12, a base station includes a transceiver 1210, a controller 1220 and a memory 1230. The transceiver 1210, the controller 1220 and the memory 1230 are configured to perform the operations of the network (e.g., gNB) illustrated in the figures, e.g., FIGS. 1 to 10 or described above. Although the transceiver 1210, the controller 1220 and the memory 1230 are shown as separate entities, they may be realized as a single entity like a single chip. The transceiver 1210, the controller 1220 and the memory 1230 may be electrically connected to or coupled with each other.

The transceiver 1210 may transmit and receive signals to and from other network entities, e.g., a terminal. The controller 1220 may control the base station to perform functions according to one of the embodiments described above. The controller 1220 may refer to a circuitry, an ASIC, or at least one processor. In an embodiment, the operations of the base station may be implemented using the memory 1230 storing corresponding program codes. Specifically, the base station may be equipped with the memory 1230 to store program codes implementing desired operations. To perform the desired operations, the controller 1220 may read and execute the program codes stored in the memory 1230 by using a processor or a CPU.

While the disclosure has been shown and described with reference to various embodiments thereof, it will be understood by those skilled in the art that various changes in form and details may be made therein without departing from the spirit and scope of the disclosure as defined by the appended claims and their equivalents.

As described above, embodiments disclosed in the specification and drawings are merely used to present specific examples to easily explain the contents of the disclosure and to help understanding but are not intended to limit the scope of the disclosure. Accordingly, the scope of the disclosure should be analyzed to include all changes or modifications derived based on the technical concept of the disclosure in addition to the embodiments disclosed herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, configuration information for a network discontinuous reception (NW DRX);
receiving, from the base station, downlink data;
identifying that an occasion for hybrid automatic repeat request (HARQ) information for the downlink data overlaps with a duration of the NW DRX; and
transmitting, to the base station, the HARQ information for the downlink data in the occasion overlapping with the duration of the NW DRX.

2. The method of claim 1, further comprising:
starting a DRX HARQ round trip time timer for downlink (drx-HARQ-RTT-TimerDL) for a corresponding HARQ process in a first symbol after an end of a transmission of the HARQ information.

3. The method of claim 2, further comprising:
upon an expiry of the drx-HARQ-RTT-TimerDL, starting a DRX retransmission timer for downlink (drx-RetransmissionTimerDL) for the corresponding HARQ process in a first symbol after the expiry of the drx-HARQ-RTT-TimerDL.

4. The method of claim 3, further comprising:
receiving, from the base station, a physical downlink control channel (PDCCH) for retransmission while the drx-Retransmission TimerDL is running.

5. The method of claim 1, wherein the downlink data is received based on a PDCCH received from the base station.

6. A method performed by a base station in a wireless communication system, the method comprising:
transmitting, to a terminal, configuration information for a network discontinuous reception (NW DRX);
transmitting, to the terminal, downlink data; and
receiving, from the terminal, hybrid automatic repeat request (HARQ) information for the downlink data in an occasion for HARQ information that overlaps with a duration of the NW DRX, by temporarily resuming a reception during the duration of the NW DRX.

7. The method of claim 6, wherein a DRX HARQ round trip time timer for downlink (drx-HARQ-RTT-TimerDL) for a corresponding HARQ process is started in a first symbol after an end of the reception of the HARQ information.

8. The method of claim 7, wherein, upon an expiry of the drx-HARQ-RTT-TimerDL, a DRX retransmission timer for downlink (drx-RetransmissionTimerDL) for the corresponding HARQ process is started in a first symbol after the expiry of the drx-HARQ-RTT-TimerDL.

9. The method of claim 8, further comprising:
transmitting, to the terminal, a physical downlink control channel (PDCCH) for retransmission while the drx-RetransmissionTimerDL is running.

10. The method of claim 6, wherein the downlink data is transmitted based on a PDCCH transmitted to the terminal.

11. A terminal in a wireless communication system, the terminal comprising:
a transceiver; and
a controller coupled with the transceiver and configured to:
receive, from a base station, configuration information for a network discontinuous reception (NW DRX),
receive, from the base station, downlink data,
identify that an occasion for hybrid automatic repeat request (HARQ) information for the downlink data overlaps with a duration of the NW DRX, and
transmit, to the base station, the HARQ information for the downlink data in the occasion overlapping with the duration of the NW DRX.

12. The terminal of claim 11, wherein the controller is further configured to:
start a DRX HARQ round trip time timer for downlink (drx-HARQ-RTT-TimerDL) for a corresponding HARQ process in a first symbol after an end of a transmission of the HARQ information.

13. The terminal of claim 12, wherein the controller is further configured to:
upon an expiry of the drx-HARQ-RTT-TimerDL, start a DRX retransmission timer for downlink (drx-RetransmissionTimerDL) for the corresponding HARQ process in a first symbol after the expiry of the drx-HARQ-RTT-TimerDL.

14. The terminal of claim 13, wherein the controller is further configured to:
receive, from the base station, a physical downlink control channel (PDCCH) for retransmission while the drx-RetransmissionTimerDL is running.

15. The terminal of claim 11, wherein the downlink data is received based on a PDCCH received from the base station.

16. A base station in a wireless communication system, the base station comprising:
a transceiver; and
a controller coupled with the transceiver and configured to:
transmit, to a terminal, configuration information for a network discontinuous reception (NW DRX),
transmit, to the terminal, downlink data, and
receive, from the terminal, hybrid automatic repeat request (HARQ) information for the downlink data in an occasion for HARQ information that overlaps with a duration of the NW DRX, by temporarily resuming a reception during the duration of the NW DRX.

17. The base station of claim 16, wherein a DRX HARQ round trip time timer for downlink (drx-HARQ-RTT-TimerDL) for a corresponding HARQ process is started in a first symbol after an end of the reception of the HARQ information.

18. The base station of claim 17, wherein, upon an expiry of the drx-HARQ-RTT-TimerDL, a DRX retransmission timer for downlink (drx-RetransmissionTimerDL) for the corresponding HARQ process is started in a first symbol after the expiry of the drx-HARQ-RTT-TimerDL.

19. The base station of claim 18, wherein the controller is further configured to:
transmit, to the terminal, a physical downlink control channel (PDCCH) for retransmission while the drx-RetransmissionTimerDL is running.

20. The base station of claim 16, wherein the downlink data is transmitted based on a PDCCH transmitted to the terminal.
